(19) United States
(12) Patent Application Publication
(10) Pub. No.: US 2025/0222980 A1
(43) Pub. Date: Jul. 10, 2025

(54) FORCE FEEDBACK AND RETURN TO CENTER FOR DRIVE-BY-WIRE STEERING SYSTEM

(71) Applicant: MTD PRODUCTS INC, Valley City, OH (US)

(72) Inventors: Zachary A. Lyzen, Seattle, WA (US); Adam J. Woodrum, Wakeman, OH (US); Katharin Jensen-Nau, Crystal, MN (US); Jeff Kucera, Medina, OH (US)

(21) Appl. No.: 19/010,398

(22) Filed: Jan. 6, 2025

Related U.S. Application Data
(60) Provisional application No. 63/618,136, filed on Jan. 5, 2024.

(51) Int. Cl. B62D 6/00; A01D 34/00; A01D 101/00; B62D 1/22; B62D 5/04

(52) U.S. Cl. CPC B62D 6/008; A01D 34/006; B62D 1/22; B62D 5/046; A01D 2101/00

(57) ABSTRACT

A drive-by-wire steering system for a power equipment device is provided. One example embodiment comprises a steering interface system, a power steering system, and a communication link connecting the steering interface system and power steering system. The power steering system can adjust an output angular displacement of steering elements of the power equipment device based on inputs received from the steering interface system. The steering interface system can receive user inputs and provide powered feedback and/or a simulated caster effect via a steering interface. Additional embodiments include power equipment devices and steering interface systems.

### INCORPORATION BY REFERENCE

The following are hereby incorporated by reference within the present disclosure in their respective entireties and for all purposes: U.S. Provisional Patent Application No. 63/618,136 filed Jan. 5, 2024; U.S. Provisional Patent Application No. 63/183,939 filed May 4, 2021, U.S. patent application Ser. No. 17/016,022 filed Sep. 9, 2020; U.S. patent application Ser. No. 17/736,141 filed May 4, 2022; U.S. Pat. No. 9,409,596 issued Aug. 9, 2016; and U.S. Pat. No. 9,944,316 issued Apr. 17, 2018.

### FIELD OF DISCLOSURE

The disclosed subject matter pertains to apparatuses and methods for drive-by-wire steering interface for power equipment, for instance, which can provide powered feedback and/or return steering control(s) to their center position(s) to improve drivability.

### BACKGROUND

Manufacturers of power equipment for outdoor maintenance applications offer many types of machines for general maintenance and mowing applications. Generally, these machines can have a variety of forms depending on application, from general urban or suburban lawn maintenance, rural farm and field maintenance, to specialty applications. Even specialty applications can vary significantly, from sporting events requiring moderately precise turf, such as soccer fields or baseball outfields, to events requiring very high-precision surfaces such as golf course greens, tennis courts and the like.

Drive-by-wire technology employs electrical or electrical-mechanical linkages to connect vehicle functions instead of mechanical linkages, allowing control of a vehicle via electronic control systems instead of mechanical controls. Various types of drive-by-wire systems have been developed in connection with road vehicles. While road vehicles have particular challenges, including those arising from the greater speeds and traffic involved, extension of drive-by-wire technology to off-road equipment often presents different challenges.

### BRIEF SUMMARY

The following presents a simplified summary in order to provide a basic understanding of some aspects of the disclosure. This summary is not an extensive overview of the disclosure. It is not intended to identify key/critical elements or to delineate the scope of the disclosure. Its sole purpose is to present some concepts of the disclosure in a simplified form as a prelude to the more detailed description that is presented later.

A first example embodiment is a drive-by-wire steering system for a power equipment machine, comprising: a steering interface system comprising: a steering interface configured to receive rotational input from a user; one or more steering interface position encoders configured to determine a control angular displacement of the steering interface relative to a center angle of the steering interface; one or more steering interface motors configured to rotate the steering interface; and one or more steering interface motor controllers configured to control activation of the one or more steering interface motors to apply one or more torques to the steering interface; a power steering system comprising: one or more steering elements; one or more steering position encoders configured to determine an output angular displacement of the one or more steering elements relative to a center angle of the one or more steering elements; one or more steering motors configured to drive the one or more steering elements; and one or more steering motor controllers configured to control activation of the one or more steering motors to drive the one or more steering elements toward a target output angular displacement, wherein the target output angular displacement is based on the control angular displacement and a steering ratio, wherein the steering interface system and the power steering system communicate via a communication link, wherein the communication link is one of a wired communication link or a wireless communication link.

A second example embodiment is a steering interface system, comprising: a steering interface configured to receive rotational input from a user; a steering interface position encoder configured to determine a control angular displacement of the steering interface relative to a center angle of the steering interface; a steering interface motor configured to rotate the steering interface; a steering interface motor controller configured to control activation of the steering interface motor to apply one or more torques to the steering interface; and a communication interface configured to output first data that indicates the control angular displacement and receive second data that indicates a heading of a power equipment machine, wherein the heading is based at least in part on the control angular displacement and a steering ratio.

A third example embodiment is a drive-by-wire steering system, comprising: a steering interface system comprising: a steering interface configured to receive rotational input from a user; one or more steering interface position encoders configured to determine a control angular displacement of the steering interface relative to a center angle of the steering interface; one or more steering interface motors configured to rotate the steering interface; and one or more steering interface motor controllers configured to control activation of the one or more steering interface motors to apply one or more torques to the steering interface; a power steering system comprising: one or more steering elements; one or more steering position encoders configured to determine an output angular displacement of the one or more steering elements relative to a center angle of the one or more steering elements; one or more steering motors configured to drive the one or more steering elements; one or more steering motor controllers configured to control activation of the one or more steering motors to drive the one or more steering elements toward a target output angular displacement, wherein the target output angular displacement is based on the control angular displacement and a steering ratio; and a Controller Area Network (CAN) bus that facilitates communication between the steering interface system and the power steering system.

To accomplish the foregoing and related ends, certain illustrative aspects of the disclosure are described herein in connection with the following description and the drawings. These aspects are indicative, however, of but a few of the various ways in which the principles of the disclosure can be employed and the subject disclosure is intended to include all such aspects and their equivalents. Other advantages and features of the disclosure will become apparent from the following detailed description of the disclosure when considered in conjunction with the drawings.

### BRIEF DESCRIPTION OF THE DRAWINGS

FIG. 1 depicts a block diagram of an example drive-by-wire steering system for a power equipment machine, according to various aspects discussed herein.

FIG. 2 depicts images of first and second example embodiments of a power equipment machine according to embodiments of the present disclosure.

FIG. 3 illustrates a picture of the first example power equipment machine of FIG. 2 with movable armrest devices and graphical display, in additional embodiments.

FIG. 4 depicts an image of the first example power equipment machine of FIG. 2 with movable armrest devices in a closed position, in another embodiment(s).

FIG. 5 illustrates additional details of movable arm with manual steering interfaces of a prototype of the first example embodiment power equipment machine.

FIG. 6 illustrates multiple cut-away views of a movable arm and components of a first embodiment of manual steering interfaces of a power equipment machine, according to various aspects discussed herein.

FIG. 7 depicts multiple views of components of the manual steering interfaces embodiment depicted in FIG. 6.

FIG. 8 illustrates images of prototype manual steering interfaces and associated components for the embodiment depicted in FIG. 6.

FIG. 9 depicts multiple images of a second embodiment of manual steering interfaces of a power equipment machine, according to various aspects discussed herein.

FIG. 10 depicts multiple images of a third embodiment of manual steering interfaces of a power equipment machine, according to various aspects discussed herein.

FIG. 11 depicts an exploded view of the third embodiment of manual steering interfaces of a power equipment machine, according to various aspects discussed herein.

FIG. 12 depicts images of a movable armrest of the second example power equipment machine of FIG. 2 (without manual steering interfaces) and a bottom view of a prototype of the third embodiment of manual steering interfaces, in connection with various aspects discussed herein.

FIG. 13 illustrates an image of an example power equipment machine comprising a steering wheel as a steering interface, employable in connection with various embodiments discussed herein.

FIG. 14 illustrates a second image of the example power equipment machine of FIG. 13, showing a closer view of electronic components that can include a position encoder, steering interface motor controller, etc., in connection with various aspects discussed herein.

FIG. 15 depicts a diagram of an example computing environment for electronic and data management and computer control for a power equipment machine, in an embodiment.

It should be noted that the drawings are diagrammatic and not drawn to scale. Relative dimensions and proportions of parts of the figures have been shown exaggerated or reduced in size for the sake of clarity and convenience in the drawings. The same reference numbers are generally used to refer to corresponding or similar features in the different embodiments, except where clear from context that same reference numbers refer to disparate features. Accordingly, the drawings and description are to be regarded as illustrative in nature and not as restrictive.

While embodiments of the disclosure pertaining to providing user feedback and enhanced drivability in drive-by-wire systems for power equipment machines are described herein, it should be understood that the disclosed machines, electronic and computing devices and methods are not so limited and modifications may be made without departing from the scope of the present disclosure. The scope of the systems, methods, and electronic and computing devices for providing user feedback and enhanced drivability in drive-by-wire systems are defined by the appended claims, and all devices, processes, and methods that come within the meaning of the claims, either literally or by equivalence, are intended to be embraced therein.

### DETAILED DESCRIPTION

The following terms are used throughout the description, the definitions of which are provided herein to assist in understanding various aspects of the subject disclosure.

As used in this application, the terms “outdoor power equipment”, “outdoor power equipment machine”, “power equipment”, “maintenance machine” and “power equipment machine” are used interchangeably and are intended to refer to any of manually operated, robotic, partially robotic ride-on, walk-behind, sulky equipped, autonomous, semi-autonomous (e.g., user-assisted automation), remote control, or multi-function variants of any of the following: powered carts and wheelbarrows, lawn mowers, lawn and garden tractors, lawn trimmers, lawn edgers, lawn and leaf blowers or sweepers, hedge trimmers, pruners, loppers, chainsaws, rakes, pole saws, tillers, cultivators, aerators, log splitters, post hole diggers, trenchers, stump grinders, snow throwers (or any other snow or ice cleaning or clearing implements), lawn, wood and leaf shredders and chippers, lawn and/or leaf vacuums, pressure washers, lawn equipment, garden equipment, driveway sprayers and spreaders, and sports field marking equipment.

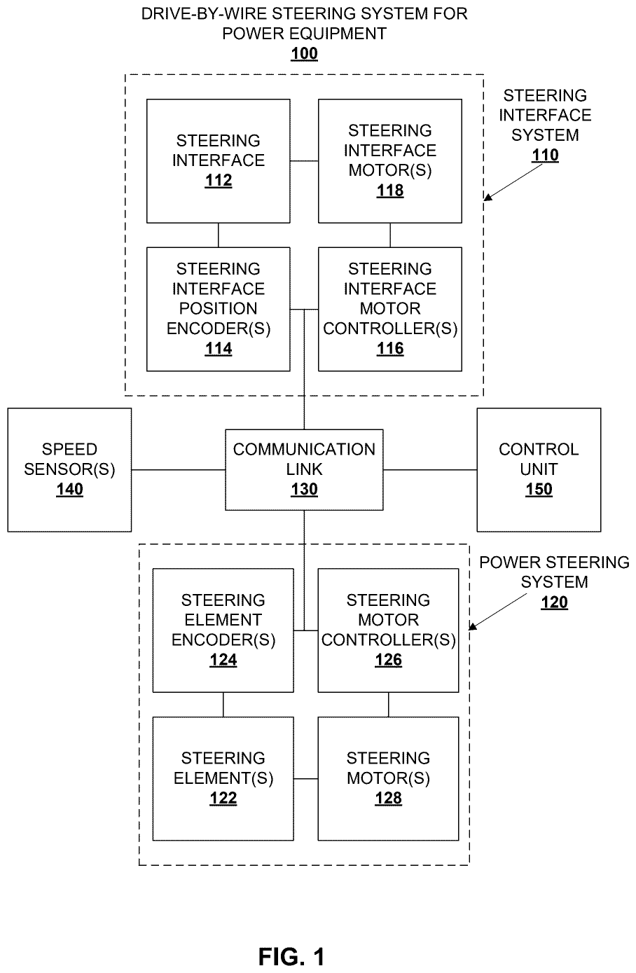

Referring to FIG. 1, illustrated is a diagram of an example drive-by wire steering system 100 for a power equipment machine, according to one or more embodiments of the present disclosure. Drive-by-wire steering system 100 can be employed in or in connection with any suitable power equipment machine disclosed herein or known in the art, such as one or more power equipment machine(s) discussed herein.

Drive-by-wire steering system can comprise a steering interface system 110 and power steering system 120 that communicate via a communication link 130 (e.g., which can be wireless or wired, such as a Controller Area Network (CAN) bus, etc.) and can optionally comprise one or more of communication link 130 (e.g., when it is a wired communication link), speed sensor(s) 140 and a control unit 150.

Steering interface system 110 can receive user inputs (e.g., for controlling steering of the power equipment machine, etc.) and angular position data indicative of a current heading from power steering system 120 and can provide resistive torque and other feedback (e.g., haptic, etc.) to the user, which can be based on information received from power steering system 120, speed sensor(s) 140, and/or control unit 150.

In various embodiments, steering interface system 110 can comprise a steering interface 112 (e.g., comprising input device(s) by which the power equipment can be steered, such as one or more steering wheel(s), lap bar(s), jogwheel(s), joystick(s), etc.), steering interface position encoder(s) 114 (e.g., which can receive signals indicating position(s) and/or angular position(s) (e.g., angle(s) of one or more steering wheel(s), lap bar(s), jogwheel(s), joystick(s), etc. and/or change(s) thereof as measured by one or more sensors or systems, such as the example Hall effect sensor discussed below, etc.), steering interface motor controller 116, and steering interface motor 118, each of which is discussed in greater detail below, as well as a communication interface (not shown) for communication over communication link 130, and an electrical power system (e.g., a battery, an alternator, a generator, or the like) and/or an electrical connection to an electrical power system (e.g., of the power equipment machine, etc.) for providing power to other elements of steering interface system 110 (also not shown).

In various embodiments, steering interface 112 receives one or more rotational inputs from an operator (and steering interface position encoder(s) 114 output signals indicating the one or more rotational inputs), such as rotation of a steering wheel or jogwheel, rotation of one or more single axis joysticks about pivot point(s), rotation of either or both of two lap bars about their pivot points, rotation of a dual axis joystick in either or both of two orthogonal directions about its pivot point, etc. However, some embodiments can comprise a steering interface 112 (e.g., slider(s), etc.) that additionally or alternatively receives one or more linear inputs from an operator (and steering interface position encoder(s) 114 output signals indicating the one or more linear inputs). In some embodiments, steering interface 112 can have mechanical stops that correspond to maximum inputs in one or more directions (e.g., mechanical limits on range of motion, etc.), such as maximum angular displacement(s) of lap bar(s) or joystick(s) (e.g., for which a maximum angular displacement is often less than 90° from a neutral position, etc.), some steering wheel(s)/jogwheel(s) (e.g., which can be configured to have mechanical stops at substantially any angular displacement, including greater than 360°, etc.), or maximum linear displacement(s) of linear input devices (e.g., which are constrained at least by the size of steering interface 112, etc.). In other embodiments, steering interface 112 can have no mechanical stops, and can be rotated to substantially any angular displacement. In some embodiments wherein steering interface 112 has no mechanical stops, steering interface motor(s) 128 can be driven to simulate the presence of mechanical stops, limiting the range of motion of steering interface 112. Simulated mechanical stops can be employed in a variety of scenarios, such as setting a fixed or user specific (e.g., based on operator size, operator skill or comfort level, whether an operator is seated or standing, etc.) range of motion for operation, while allowing motion outside of that range in other scenarios (e.g., lap bars that can fold fully forward when not in use, a wider range of operation for some users or when a user is seated/standing, etc.). The presence or absence of mechanical stops (or simulated mechanical stops) in steering interface 112 can affect the behavior of system 100, as described in greater detail below.

Power steering system 120 can monitor angular position(s) and/or speed(s) of one or more steering elements (e.g., front wheels, differentially driven drive wheels, etc.) 122 of the power equipment machine, can provide angular position data for the steering element(s) 122 (e.g., which can be determined from the monitored angular position(s) and/or speed(s) as discussed herein) to steering interface system 110 and/or control unit 150, and can control the orientation and/or speed of steering element(s) 122 (or otherwise control power steering system 120 to obtain a given heading/turning radius, depending on the embodiment, as discussed in greater detail below) based on inputs from steering interface system 110 and/or control unit 150. Power steering system 120 can comprise the steering element(s) 122, steering element encoder(s) 124 for the steering element(s) 122 (e.g., which can receive signals indicating speed/angular position and/or change thereof from one or more sensors or systems, such as the example Hall effect sensor discussed below, etc.), steering motor controller(s) 126, and steering motor(s) 128, each of which is discussed in greater detail below, as well as a communication interface (not shown) for communication over communication link 130, and an electrical power system (e.g., a battery, an alternator, a generator, or the like) and/or an electrical connection to an electrical power system (e.g., of the power equipment machine) for providing power to other elements of steering system 120 (also not shown).

The nature of the angular position data indicative of a current heading can vary between embodiments and can depend in some embodiments on the steering element(s) 122 of power steering system 120. As a first example, if steering element(s) 122 comprise one or more passively or actively steered wheels or other elements with a plane of rotation that can vary and which are all at a given angle (e.g., relative to a direction straight forward from the outdoor power equipment that comprises steering element(s) 122, etc.), the angular position data can indicate the given angle (e.g., or a quantity derived therefrom, etc.). As a second example, if similar steering elements 122 have respective planes of rotation at two or more different angles relative to forward for the outdoor power equipment (e.g., for Ackermann steering, etc.), the angular position data can indicate an extent of deviation from straight forward motion, can indicate a turning radius, etc. As a third example, if steering elements 122 are drive elements (e.g., drive wheels, etc.) driven at two or more speeds that can be the same (for forward motion) or can differ from each other (to effectuate differential steering), the angular position data can indicate an extent of deviation from straight forward motion, can indicate a radius associated with the turn, etc. In general, the angular position data associated with a given time can indicate a value derived from the extent of deviation from forward motion and/or a steering radius, can have a neutral position corresponding to forward motion (e.g., or an infinite turning radius, etc.), and can otherwise indicate both the direction (e.g., left or right turns, which can be indicated in multiple ways, such as via positive or negative values, etc.) and magnitude (e.g., with greater magnitude corresponding to greater deviation from forward motion/smaller turning radius, etc.) of a turn at the given time.

Communication link 130 can facilitate communication between other components of system 100, and depending on the embodiment, communication link 130 can be a wired communication link (e.g., a bus such as a Controller Area Network (CAN) bus, etc.) and/or wireless communication link (e.g., any suitable public, private or commercial cellular voice or data network (second generation (2G), 3G, 4G, WiMAX, 4G long term evolution (LTE), 5G, and so forth), a satellite voice or data network, Bluetooth®, or Wi-Fi technology IEEE 802.11 (a, b, g, n, . . . ), infrared, Ultra-Wideband (UWB), etc.). In embodiments employing a wired communication link 130 and in some embodiments employing a wireless communication link 130, system 100 can be wholly comprised within the power equipment machine. In other embodiments employing a wireless communication link 130, power steering system 120, speed sensor(s) 140 (when included), and optionally control unit 150 (when included) can be comprised with the power equipment machine, while steering interface system 110 and optionally control unit 150 (when included) can be comprised within a separate device for remote control of the power equipment machine.

In embodiments that comprise speed sensor(s) 140, speed sensor(s) can monitor a speed (e.g., ground speed) of the power equipment machine (e.g., via drive element(s), etc.), and can provide speed data to steering interface system 110 and/or control unit 150. Additionally or alternatively, ground speed can be determined based on external data, such as location data received from a communication network or global positioning system (GPS) (e.g., which can include similar and/or related techniques, such as GPS with Real Time Kinematics (GPS-RTK)), etc., and can similarly be provided to steering interface system 110 and/or control unit 150.

In embodiments that comprise control unit 150, control unit 150 can receive angular position data from power steering system 120 and optionally location or other data (e.g., external data from a communication network or GPS, internal data from ground speed or machine vision sensors, etc.) used for an autonomous or semi-autonomous mode, and can control power steering system 120 based on an autonomous or semi-autonomous driving mode (e.g., autonomous turning such as autonomous U-turns, etc.). Additionally, in some embodiments, control unit 150 can receive information from steering interface system 110, power steering system 120, and/or speed sensor(s) 140 and coordinate operation of system 100 according to a manual mode as discussed in greater detail herein.

In various embodiments, drive-by-wire steering system 100 can provide powered feedback to a user of the power equipment machine, and/or provide a torque to return the steering controls to a neutral position (e.g., by simulating the effect of a positive caster angle, independent of any actual positive, zero, or negative caster angle, etc. on the steerable element(s) 122 of the power equipment machine, although other torques with a different dependence (or lack thereof) on angle or speed can also be applied, etc.), as described in greater detail below.

In various embodiments, steering interface 112 can be comprise any of a variety of rotational and/or linear input devices, with or without mechanical stops. Additionally, in various embodiments, steering interface 112 can be used solely for steering control (e.g., a steering wheel, etc.), or can be used for control of both steering and speed (e.g., a pair of lap bars each controlling separate drive elements to effect differential steering, etc.). However, for ease of discussion, various example embodiments discussed herein employ rotational inputs for steering interface 112 (in the context of embodiments discussed herein, linear input steering interfaces are functionally equivalent to rotational input steering interfaces with mechanical stops). Example embodiments shown in the figures include steering wheel, jogwheel, and lap bar embodiments, but the features and aspects discussed herein can be employed in connection with a variety of steering interfaces. In connection with some features and aspects of various embodiments, the presence or absence of mechanical stops and/or whether steering interface 112 additionally controls speed can be relevant, and differences relating to those scenarios are discussed below.

For ease of discussion, steering interface 112 is discussed in the context of a rotational input/output device (e.g., such as a steering wheel, lap bar(s), joystick(s), jogwheel, etc.) that can be rotated clockwise (CW) or counterclockwise (CCW) by a user and/or steering interface motor 118 as driven by steering interface motor controller 116 according to various aspects discussed herein (in other embodiments, analogous techniques can be employed with translational input devices). Steering interface 112 can have a neutral point or center angular position (center position for linear steering inputs) that can be defined (and in some scenarios redefined, as discussed herein) to be associated with a center angle of steerable wheel(s) 122. The center angle of steering element(s) 122 is the angle (or a combination of drive element speeds) such that power equipment machine will drive straight (forward or backward) while the steering element(s) 122 are at their center angle (if they have an adjustable plane of rotation) or the steering element(s) 122 are all driven at the same speed (e.g., for differential steering embodiments). Rotation of steering interface 112 in a given (e.g., CCW or CW) direction from its neutral point commands (e.g., generates an output to power steering system 120, etc.) a turn in the given direction (e.g., for forward motion, to the left or right, respectively, which correspond to CCW or CW, respectively, when viewed from above) with the angle of the turn increasing (or at least nondecreasing) and the turning radius decreasing (or at least nonincreasing) as the steering interface is rotated farther in the given direction from its neutral point. In example embodiments discussed herein, the mapping between the angular displacement of a steering wheel (or jogwheel, etc.) and the commanded steering angle for steering element(s) can be linear, although in other embodiments, nonlinear (e.g., including piecewise linear) mappings can be employed (e.g., less responsive steering for smaller angular displacements of steering interface 112, etc.). Inputs to other types of rotational steering interfaces (e.g., tilting of lap bar(s), joystick(s), etc.) can similarly map a rotational input (or in scenarios such as differential steering, a combination of rotational inputs, e.g., a difference, etc.) to a commanded steering angle or turning radius, and inputs to linear steering interfaces can similarly map linear inputs to a commanded steering angle or turning radius.

As noted, substantially any mapping such that increasing CW/CCW control angular displacement maps via a nondecreasing function to CW/CCW turns (e.g., based on an angle of turn, a turning radius of the turn, etc.) can be employed, which can allow for control over a greater range of motion than with existing mechanically linked steering interfaces otherwise similar to steering interface 112. For example, specific CW/CCW control angular displacements of steering interface 112 can be defined (and in some embodiments, redefined) that can correspond to zero radius CW/CCW turns, etc.

In some embodiments, the CW/CCW control angular displacements that correspond to zero-radius turns can be less than the maximum allowed CW/CCW control angular displacement(s) for which there are corresponding output angular displacements, allowing for CW and/or CCW range(s) beyond zero-radius turns (e.g., “negative radius” turns (the radius remains positive, but is on the opposite side of the vehicle) wherein the center of rotation of the turn is on the other side (e.g., left for CW and right for CCW, etc.) than for turns (e.g., left for CCW and right for CW, etc.) with a control angular displacement of lower magnitude than that corresponding to a zero-radius turn) that can correspond to different outputs in different embodiments or modes. For example, in some embodiments, turns with CW/CCW control angular displacement beyond that corresponding to a zero-radius turn can cause CCW/CW output angular displacement coupled with forward motion, while in other embodiments, reverse motion around the same center of rotation as that CCW/CW turn can result.

For some types of steering input 112, there is a unique input center angular position or neutral point (e.g., which can be redefined in some embodiments to a different, but still unique, input) that corresponds to no turn being commanded (e.g., as an output signal to power steering system 120, etc.). However, for other types (e.g., differential steering, etc.) of steering input 112, there are multiple input neutral points such that no turn is commanded. However, for each commanded drive speed, there is a unique input that corresponds to the neutral point at that commanded drive speed. As discussed herein, unless otherwise indicated, the “neutral point” of a steering interface 112 is either the unique input neutral point that corresponds to no turn being commanded or is the unique input neutral point that corresponds to no turn being commanded at the currently commanded drive speed (in embodiments employing a dead band or other similar features to damp or eliminate small inputs to steering interface 112, the neutral point can be a center point of the deadband, etc. or the center point of the deadband, etc. for the currently commanded drive speed).

In some embodiments, a display or other indicator can indicate to an operator the direction of motion of the power equipment machine resulting from a given control angular displacement (e.g., a small display showing an arrow indicating the direction of motion, etc.). Additionally or alternatively, some embodiments (e.g., without mechanical stops, etc.) can comprise one or more operator inputs (e.g., button, switch, portion of a touchscreen, etc.) that can allow for redefinition of the center angle of steering interface 112 based on operator input, such as one or more of: an input to reset the center angle such that the direction of motion of the power equipment machine resulting from the redefined control angular displacement will be straight forward, an input to reset the center angle such that the direction of motion of the power equipment machine resulting from the redefined control angular displacement will be the opposite of the direction of motion prior to redefinition, etc.

Rotation of steering interface 112 can be measured and monitored by steering interface position encoder(s) 114, such that steering interface position encoder(s) 114 can store angular displacement(s) (e.g., a single angular displacement, one for each of two lap bars or single axis joysticks, one for each axis of a dual axis joystick, etc.) of steering interface 112 relative to the center angular position of steering interface 112, and steering interface position encoder(s) 114 can periodically output that angular displacement over communication link 130.

Steering interface motor 118 can be configured to rotate (or apply braking to) steering interface 112 as driven by steering interface motor controller 116 according to aspects discussed herein. Steering interface motor 118 can apply torque (or force, in linear steering interface embodiments) to steering interface 112 via driving or braking applied via steering interface motor controller 116 to achieve one or more effects discussed herein, including resistive torque for one or more of: simulation of a caster effect, powered feedback, haptic feedback to a user, etc.

Steering (e.g., rotation of steerable wheels, differential speeds of drive elements, etc.) via steering element(s) 122 can be measured and monitored by steering element encoder(s) 124, such that steering element encoder(s) 124 can store an angular displacement (or its effective equivalent for differential steering embodiments, wherein both an angular displacement and the combination of drive speeds can be associated with a turn of a given radius) of steering element(s) 122 relative to the center angle of steering element(s) 122, and steering element encoder(s) 124 can periodically output the angular displacement over communication link 130.

Steering motor(s) 128 can be driven by steering motor controller(s) 126 to rotate steering element(s) 122 to execute commanded turns (as used herein, rotating steering element(s) to execute a commanded turn includes driving them such that they execute the commanded turn, which in some embodiments includes changing a plane of rotation of steerable wheel(s), and in the same or other embodiments includes rotating multiple drive elements about their respective axes of rotation at different speeds to execute the commanded turn, etc.) received via communication link 130. Steering motor(s) 128 can apply torque to steering element(s) 122 via motor activation or braking by steering motor controller(s) 126 to rotate steering element(s) based on inputs received from steering interface system 110 and/or control unit 150. One or more torques can be applied (separately or in any applicable combination) in various scenarios, as discussed below.

For ease of discussion, various example embodiments discuss relationships between the angular position of a steering interface (e.g., a control angular position, etc.) and the angular position of steering element(s) (e.g., an output angular position, etc.), and example embodiments discuss these relationships in connection with steering elements that are steerable wheels and a rotational steering interface such as a steering wheel, jogwheel, etc. However, while many embodiments employ physically steerable wheel(s) that change a physical axis of rotation of those steerable wheel(s) to change a direction of motion of the power equipment machine, other types of steering systems can be employed. As a first non-limiting example, in some power equipment devices, steering can be controlled by separate motors that can apply different speeds on a pair of drive wheels, tracks, etc. to rotate one drive wheel, track, etc. faster than the other, inducing a turn with the slower driven wheel, track, etc. on the inside of the turn, and vice versa. As a second non-limiting example, some power equipment devices are capable of rotating two or more steerable wheels into non-parallel planes to turn the power equipment machine along an intended heading (e.g., zero turn power equipment machines, etc.). Accordingly, while for ease of illustration, the physical angle of steerable wheels is discussed, more generally, at any given speed the direction and extent to which the heading of a power equipment machine will curve can correspond in general to a unique state of the steering element(s) 122 (e.g., relative speeds of drive wheels, wheel angle(s) or wheel angular position(s) which can be the same or different for multiple steerable wheels, etc.). Thus, each state of the steering element(s) 122 associated with a given speed is associated with either no turn (referred to herein as the “center angle”) or a left- or righthand turn at a given angle or turning radius. Accordingly, while in some embodiments the angle of the steering element(s) refers to a literal angle that the plane of rotation of a steerable wheel, etc. is rotated relative to its center angle, in other embodiments the angle of the steering element(s) includes the state (e.g., combination of angle(s) and/or drive speed(s), etc.) of the steering element(s) (e.g., potentially at a given power equipment speed) that causes the power equipment to turn at that angle or with a corresponding turning radius.

In general, for a given commanded angle received by the power steering system 120, for example, relative to a center angle (where a center angle includes an arrangement of power steering system 120 such that there is no curvature, such as the same drive speed on all drive wheels, etc.), the power steering system 120 is configured to control the heading (e.g., by varying drive speeds of wheels, independently varying angles of two or more steerable wheels, etc., to achieve a given turn) to correspond to the input from steering interface 112 similarly to the specific embodiments discussed herein.

In response to a control angular displacement of steering interface 112 (e.g., via user input), which can be communicated by steering interface position encoder 114, steering element encoder(s) 124 can instruct steering motor controller(s) 126 to drive steering motor(s) 128 to align steering element(s) 122 such that the power equipment's heading has a given output angular displacement (if not already aligned). In various embodiments, a control angular displacement of steering interface 112 can correspond with an output angular displacement of steerable wheel(s) 122 based on a given steering ratio R (e.g., 6, 1-12, etc.). For example, for a steering ratio of six, a given control angular displacement will be a factor of six greater than the corresponding output angular displacement (e.g., a 60° CW control angular displacement will correspond to a 10° CW output angular displacement). In various embodiments, a default steering ratio can be employed, and in some embodiments, a user can alter or select the steering ratio (e.g., when the power equipment machine is in a parked state, off, etc.). In the same or other embodiments, the steering ratio can change based on a drive or ground speed of the outdoor power equipment (e.g., a higher ratio at higher speeds, etc.). In some scenarios, the relationship between control angular displacement and output angular displacement can be nonlinear (e.g., with greater or lesser responsiveness for certain range(s) of control angular displacement than other range(s), etc.), the steering ratio can be a scale factor for the relationship between control angular displacement and output angular displacement (e.g., with a steering ratio R a control angular displacement of 30° CW from the center angle corresponds to a 5° CW output angular displacement and a control angular displacement of 60° CW from the center angle corresponds to a 15° CW output angular displacement, while with a steering ratio 2R a control angular displacement of 30° CW from the center angle corresponds to a 10° CW output angular displacement and a control angular displacement of 60° CW from the center angle corresponds to a 30° CW output angular displacement).

### Baseline Resistive Torque

As a first scenario in which a torque can be applied to steering interface 112, in various embodiments, steering interface motor 118 can be driven to apply a first resistive torque to steering interface 112, which can be a small baseline resistive torque with a constant magnitude (e.g., 0.5 in-lb, 0.25-0.75 in-lb, etc.) applied in opposition to user inputs (while example embodiments discuss torques, embodiments with linear steering interfaces 112 can analogously apply forces). In various embodiments, a default baseline resistive torque can be employed, and in some embodiments, a user can alter or select the baseline resistive torque (e.g., when the power equipment machine is in a parked state, off, etc.). Applying at least some resistive torque to steering interface 112 can improve drivability by reducing potential oversteering that can result from steering interface 112 turning too easily. In some scenarios (e.g., during autonomous driving or turning, etc.), steering interface motor controller 116 can apply braking to instead of driving steering interface motor 118, which can provide resistive torque in appropriate scenarios when there is no current user input.

### Torque(s) Related to Range of Motion of Steering Element(s)

Because steering interface 112 is not connected to steering element(s) 122 via a mechanical linkage, in some embodiments it is possible for a user to rotate steering interface 112 to a control angular displacement that corresponds to an output angular displacement beyond the range of motion of steering element(s) 122 (as an example, for a steering ratio of 6 and a maximum output angular displacement of 110°, a control angular displacement greater than 660° (e.g., 720°) would correspond to an output angular displacement beyond the maximum output angular displacement, e.g., past wheel lock, etc.). As a second scenario in which a torque can be applied to steering interface 112, in various embodiments, steering interface motor 118 can be driven to apply a second resistive torque to steering interface 112 to oppose user input(s) that would rotate steering interface 112 to an angular displacement corresponding to an output angular displacement beyond the range of motion of steering element(s) 122. The second torque can give a user a better feel for when steering element(s) 122 are (or are about to be) at a maximum of their range of motion (e.g., wheel lock, etc.). This second resistive torque can be greater than the first resistive torque, and in various embodiments can have a magnitude greater than 5 in-lb (e.g., 5-10 in-lb, 6-8 in-lb, etc.). Additionally, in some embodiments, the second resistive torque can be applied in a reduced form that increases from an initial value (e.g., zero, 0.5 in-lb, etc.) at a threshold output angular displacement to its maximum value at a maximum output angular displacement (e.g., linearly, with some polynomial dependence, etc.). In some embodiments, the threshold output angular displacement can be within 5° of the maximum output angular displacement (e.g., 0°, 1°, 2°, 3°, 4°, 5°, etc.). In various embodiments, a default maximum second resistive torque and/or threshold angular displacement can be employed, and in some embodiments, a user can alter or select these values (e.g., when the power equipment machine is in a parked state, off, etc.).

In embodiments where steering interface 112 has mechanical stops that it cannot be rotated or otherwise moved beyond, in some scenarios, these mechanical stops can be aligned with maximum output angular displacements of the steering element(s), such that a maximum CW (or CCW) control angular displacement corresponds to a maximum CW (or CCW) output angular displacement. In other scenarios, however, the mechanical stops need not be aligned with the maximum output angular displacements of the steering element(s). For example, the maximum CW/CCW output angular displacements can be aligned with CW/CCW control angular displacements less than the maximum CW/CCW control angular displacements, improving maneuverability over directly aligning maximum angular displacements. As another example, the maximum CW/CCW output angular displacements can be aligned with CW/CCW control angular displacements greater than the maximum CW/CCW control angular displacements, limiting maneuverability over directly aligning maximum angular displacements, and preventing a range of CW/CCW output angular displacements. In some scenarios, the alignment of maximum CW/CCW output angular displacements relative to maximum CW/CCW control angular displacements (e.g., via a steering ratio, etc.) can vary based on speed, providing greater maneuverability at lower speeds.

As discussed above in connection with the second torque, in some scenarios (e.g., a steering interface 112 with no mechanical stop(s), a steering interface 112 with mechanical stop(s) corresponding to an output angular displacement beyond an operating range of steering element(s) 122, etc.) a user can continue to rotate steering interface 112 past a control angular displacement that corresponds to a maximum output angular displacement of steering element(s) 122 (e.g., wheel lock, etc.).

In some embodiments (e.g., a steering interface 112 with no mechanical stop(s), etc.) employing the second torque, such additional rotation in the same direction can be ignored as input (e.g., by steering interface position encoder 114, etc.), such that, regardless of any further rotation in that direction, the center angle of steering interface 112 is redefined such that the current angular position of steering interface 112 corresponds to the maximum output angular displacement of steering element(s) 122 (e.g., wheel lock, etc.), and any rotation in the opposite direction can result in rotating steering element(s) 122 in the opposite direction, without the need for the user to first undo all of the excess rotation. Continuing from the example discussed above, with a steering ratio of 6 and wheel lock at 110°, rotation of steering interface 112 in a given direction (e.g., CW) by 660° or any greater amount (e.g., 720°, 1080°, etc.) will result in steering interface 112 being regarded as having an angular displacement of 660° CW (corresponding to wheel lock), and any subsequent CCW rotation will cause steering element(s) 122 to be rotated CCW (e.g., a subsequent 660° CCW rotation of steering interface 112 will return steering element(s) 122 to their center angle).

In other embodiments (e.g., a steering interface 112 with mechanical stop(s), etc.) employing the second torque, the center angle of steering interface 112 can remain at its initial value (or initial value for that drive speed, etc.) even if steering interface 112 is at a current angular position corresponding to an output angular position beyond the range of motion of steering element(s) 122, as redefinition can limit the useable range of steering interface 112 in one direction due to the presence of mechanical stops on steering interface 112.

In some embodiments (e.g., a steering interface 112 without mechanical stop(s), a steering interface 112 with mechanical stop(s) that will not be met within the range of motion of steering element(s) 122, etc.), a larger second torque can be applied to resist attempts to move steering interface beyond control angular displacement(s) corresponding (e.g., based on a steering ratio, etc.) to maximum output angular displacement(s) of steering element(s) 122. In some such embodiments, the second torque can have a value sufficient to prevent motion beyond control angular displacement(s) corresponding to maximum output angular displacement(s), to function similarly to mechanical stop(s) at those control angular displacement(s). In other such embodiments, the second torque can have a value beyond those control angular displacement(s) that increases with greater control angular displacement, to function as a stop with more give.

### Torque(s) Related to Maximum Rate of Change of Steering Element(s)

In some scenarios, a user can rotate steering interface 112 faster than steering motor(s) 128 can be driven to rotate steering element(s) 122 (or change the speed of steering element(s) in differential steering embodiments, etc.) to track that user input. As a third scenario in which a torque can be applied to steering interface 112, a third resistive torque can be applied (e.g., by steering interface motor 118) to align steering interface 112 with a control angular displacement that corresponds to the output angular displacement of the steering element(s) 122 (e.g., which can be based on the steering ratio, such that, for example, for a steering ratio of R and output angular displacement of 45° CCW from center, the torque would be applied to align steering interface 112 with an angular displacement of R×45° CCW from its center angle, etc.). In various embodiments, this third resistive torque can increase with an increasing difference between the current control angular displacement and the control angular displacement corresponding to the current output angular displacement, and/or can be applied only when that difference exceeds a threshold value (e.g., 1-4° of output angular displacement, etc.). Because the third torque will occur while steering motor controller(s) 126 are in the process of driving steering motor(s) 128 to align the output angular displacement of steering to element(s) 122 to correspond to the current control angular displacement, this resistive torque will arise in scenarios in which steering interface 112 is rotated faster than steerable element(s) 122 are turned by steering motor(s) 128 (or faster than their speed changes, in differential steering embodiments). Thus, the third resistive torque can provide feedback to a user to indicate that they are attempting to steer more rapidly than power steering system 120 is capable, simulating some of the feedback available in steering systems employing mechanical linkages instead of drive-by-wire. In various embodiments, values for the third resistive torque can range between those for the first and second resistive torques, depending on the magnitude of the difference between the current control angular displacement and the control angular displacement corresponding to the current output angular displacement. Additionally, in various embodiments, a default maximum third resistive torque and/or threshold difference can be employed, and in some embodiments, a user can alter or select these values (e.g., when the power equipment machine is in a parked state, off, etc.).

### Simulated Caster Effect Torque

Caster angle is the angular offset of a steering axis from vertical when viewed from the side of the wheel. Most automobiles have a positive caster, where the steering axis, if extended beyond the wheel, will intersect the ground in front of the contact patch of the tire. Positive caster can improve directional stability via the caster effect, which provides a torque that pushes the front wheels of the automobile toward their center angle and increases with speed. Unlike automobiles, many power equipment machines do not have a positive caster, and thus do not have a caster effect.

As a fourth scenario in which a torque can be applied to steering interface 112, in various embodiments, steering interface motor 118 can be driven to apply a simulated caster effect to steering interface 112 as a fourth torque that acts to restore steering interface 112 to its center angle. In various embodiments, the simulated caster effect torque can have a magnitude that increases with one or more of angular displacement of the steering interface 112 and/or speed of the power equipment machine (e.g., based on speed data received from speed sensor(s) 140, etc.). The intensity of the simulated caster effect torque can vary between embodiments (and potentially be selectable by a user), but in many embodiments can have a maximum value below that of the second torque (e.g., for normal operation, a value could be selected such that it will return steering input 112 to its center angle (and thus return steering element(s) 122 to center) absent any user input, but can be readily offset in part or entirely with moderate friction applied by the user to steering input 112, etc.). Additionally, unlike a true caster effect, the simulated caster effect torque has greater flexibility in how it can depend on angular displacement and/or speed (e.g., linearly, with some polynomial dependence, etc.). Various embodiments can apply at least a minimum value for the simulated caster effect torque (e.g., the minimum value can be applied in situations in which at least some simulated caster effect torque is applied, such as situations where both the control angular displacement and ground speed are non-zero, but not applied when the simulated caster effect torque would be zero, etc.) when the steering wheel(s) are not at their center angle, which can ensure the steering element(s) 122 return to their center angle relatively quickly absent user input to maintain a turn (or absent an autonomous or semi-autonomous turn, as discussed below). In various embodiments, a default simulated caster effect torque can be employed based on various parameters (e.g., intensity, speed dependence, angular displacement dependence), and in some embodiments, a user can alter or select these values or between different preset options for the simulated caster effect (e.g., when the power equipment machine is in a parked state, off, etc.).

### Torque(s) Related to Autonomous/Semi-Autonomous Operation

In some embodiments, system 100 can be employed on a power equipment machine capable of autonomous and/or semi-autonomous driving (e.g., executing an autonomous u-turn, etc.), such as discussed in greater detail below. During autonomous and/or semi-autonomous driving, control unit 150 can control operation of steering interface motor 128 via steering motor controller(s) 126 without user input. The manner of operation of autonomous and/or semi-autonomous driving can vary between embodiments, and in some scenarios can depend on the presence or absence of mechanical stops in steering interface 112. In various embodiments, while the power equipment machine is operating autonomously or semi-autonomously, sufficient user input via steering interface 112 (e.g., rotation by more than a threshold angular displacement, applying more than a threshold torque, etc.) can end the autonomous or semi-autonomous mode and return the power equipment machine to a manual mode. A fifth scenario in which torque (e.g., braking torque(s) and/or torque(s) via actively driving steering interface motor(s) 118, etc.) can be applied is in connection with (e.g., before, during, and/or after) autonomous and/or semi-autonomous operation of a power equipment machine comprising system 100.

In a first set of embodiments (e.g., some embodiments with steering interface 112 having no mechanical stops, etc.) employing the fifth torque in autonomous and/or semi-autonomous scenarios, steering interface motor controller 116 can suspend any driving of steering interface motor(s) 118 to provide resistive torque and/or a simulated caster effect to steering interface 112. Instead, steering interface motor controller 116 can apply braking via steering interface motor 118 to steering interface 112 to prevent accidental turning (e.g., caused by vibration of the power equipment machine, etc.) and provide resistance to potential user input.

When the power equipment machine is returned to a manual mode from an autonomous or semi-autonomous mode (e.g., upon finishing executing an autonomous u-turn, based on user input, etc.) in this first set of embodiments, the previously defined center angle of steering interface 112 can be redefined such that the current control angular displacement of steering interface 112 can correspond to the current output angular displacement of steering element(s) 122. As an example, assuming a steering ratio of 6, if steering interface 112 and steering element(s) 122 had no angular displacement(s) (were at their center angles) when entering an autonomous or semi-autonomous mode, but manual mode was resumed when the steering element(s) 122 had a 15° CCW angular displacement, the center angle of steering interface 112 would be redefined such that its position upon entering manual mode was a 90° CCW angular displacement (i.e., the control angular displacement corresponding to the output angular displacement).

In some scenarios of the first set of embodiments, the redefinition of the center angle of steering interface 112 can involve different torque(s) being applied to steering interface 112 by steering interface motor 118, even though steering interface 112 may not have been physically rotated between entering and exiting the autonomous or semi-autonomous mode. As one example, a user can rotate steering interface 112 to a control angular displacement corresponding to a maximum output angular displacement of steering element(s) 122, and steering interface motor 118 can be driven to apply, for example, the first, second, and fourth torques discussed above. Next, the user can activate an autonomous u-turn mode, at which point steering interface motor controller 116 can apply braking via steering interface motor 118 to steering interface 112 to prevent accidental rotation. As the power equipment machine completes the autonomous u-turn and returns to manual mode, steering element(s) 122 can be at their center angle, and the center angle of steering interface 112 can be redefined to be its current angular position. Because steering interface 112 is now at its center angle, steering interface motor controller 116 can skip applying the second and fourth torques, even though they were applied prior to the autonomous u-turn when steering interface 112 was at the same physical position, because that position has a new meaning based on the redefined center angle.

In a second set of embodiments (e.g., with steering interface 112 having mechanical stops, some embodiments with steering interface 112 having no mechanical stops, etc.) employing a fifth torque in autonomous and/or semi-autonomous scenarios, the center angle (or center angle for a given speed) of steering interface 112 can have a fixed value that is not redefined. Because of this, when ending autonomous and/or semi-autonomous operation, the control angular displacement of steering interface 112 (e.g., relative to its center angle, etc.) can correspond (e.g., via the steering ratio, etc.) to the output angular displacement of steering element(s) 122 (e.g., relative to their center angle(s), etc.). In various embodiments of the second set, during autonomous/semi-autonomous operation, steering interface motor controller(s) 116 can control steering interface motor(s) 118 to drive steering interface 112 to have control angular displacement(s) that correspond to the output angular displacement(s) employed at the same time during autonomous/semi-autonomous operation. In such embodiments, an operator can end autonomous/semi-autonomous operation at any point (e.g., by applying greater than a threshold torque/force to steering interface 112, pressing a button (or portion of a touchscreen, etc.), flipping a switch, etc.), and steering interface 112 will already have a control angular displacement aligned with the output angular displacement of steering element(s) 122. Alternatively, some embodiments of the second set of embodiments can employ autonomous/semi-autonomous operation without driving steering interface 112, until a transition period at the end of autonomous/semi-autonomous operation wherein steering interface motor controller(s) 116 can control steering interface motor(s) 118 to drive steering interface 112 to a control angular displacement corresponding to the current output angular displacement of steering element(s). As examples, this can be employed in embodiments wherein the corresponding control angular displacement can be quickly reached from the range of possible control angular displacements steering interface 112 could have had upon commencing autonomous/semi-autonomous operation, such as where a low steering ratio and/or small/light steering interface 112 (e.g., joystick(s), etc.) are employed. Alternatively, this can be employed in substantially any embodiment by stopping the power equipment machine and then aligning steering interface 112 with steering element(s) 122 before resuming manual operation.

### Torque(s) Related to Motor Load

As a sixth scenario in which a torque can be applied to steering interface 112, in various embodiments, steering interface motor(s) 118 can be driven to apply resistive torque to steering interface 112 to represent load(s) encountered by steering motor(s) 128 in operation. For example, some types of terrain and/or vegetation (e.g., mud, thick and/or wet grass, etc.) or certain activities (e.g., pushing heavy material, etc.) cause steering motor(s) 128 (as well as drive motors on the power equipment, if separate from steering motor(s) 128) to have a greater load and draw more current for the same effect than with other types of terrain, vegetation, and/or activities, etc. However, as long as the operating conditions are within the capabilities (e.g., such that the relevant motor(s) can provide the commanded drive and/or turn speed, etc.) of the power steering system (and/or drive system, if distinct from the power steering system, etc.), existing drive-by-wire steering systems do not provide user feedback that indicates these changes in operating conditions. As a result, an operator of a power equipment machine employing such a drive-by-wire steering system loses the ‘feel’ of a comparable mechanical, hydrostatic, etc. steering system, because the existing drive-by-wire steering system does not provide an operator feedback of these operating conditions.

In various embodiments, a sixth torque can be employed to provide a resistive torque to oppose steering commands (e.g., rotating steering interface 112 CW or CCW from a current control angular displacement of steering interface 112 corresponding to a current output angular displacement of steering element(s) 122 can be opposed by a torque that is CCW or CW, respectively) and/or drive commands, wherein the sixth torque can have a magnitude that depends on the load or current draw of the steering motor(s) 128 and/or drive motor(s). In general, the sixth torque can be a nondecreasing function of the load/current draw on the relevant motor(s), but the exact dependence can vary between embodiments, such as linear, piecewise linear, polynomial, step function(s), etc. In some embodiments, a lower threshold load/current draw can be employed such that for a load/current draw below the lower threshold, the sixth torque is not applied. Additionally or alternatively, an upper threshold load/current draw can be employed such that for a load/current draw above the upper threshold, the sixth torque has a maximum magnitude.

### Torque(s) Relating to Alignment of the Steering Interface with the Steering Element(s)

As a seventh scenario in which a torque can be applied to steering interface 112, in various embodiments, steering interface motor(s) 118 can be controlled to drive steering interface to one or more control angular displacements that correspond to one or more output angular displacements of steering element(s) 122. In some scenarios, steering interface 112 can be at a control angular displacement that does not correspond to the output angular displacement of steering element(s) 122. When this results from operator input during manual operation, steering motor(s) can drive steering element(s) 122 to the output angular displacement corresponding to the control angular displacement, as discussed above. However, this lack of alignment can occur in other situations (e.g., at initial startup, when returning to manual operation following autonomous and/or semi-autonomous operation, etc.) wherein rotating steering interface 112 may be preferable to rotating, etc. steering element(s) 122. In such scenarios, the power equipment can be brought to a stop if in motion, and then steering interface 112 can be rotated until the control angular displacement corresponds to the output angular displacement of steering element(s) 122.

Additionally, in some embodiments, a calibration procedure can be implemented wherein steering interface motor(s) 118 drive steering interface 112 simultaneously with steering motor(s) 128 driving steering element(s) 122 through a range and/or a plurality of control angular displacements (e.g., maximum CW, center angle, and maximum CCW, etc.) and corresponding output angular displacements to ensure calibration between control angular displacements and output angular displacements. In some such embodiments, calibration data can be stored (e.g., by control unit 150 in a coupled memory, etc.) indicating a plurality of control angular displacements and corresponding output angular displacements.

### Additional Torque(s)

The torques discussed above can be applied to steering interface 112 to provide multiple advantages in terms of improving drivability of a power equipment machine, such as simulating the feedback available in steering systems that employ mechanical linkages and improving directional stability.

Additionally, in various embodiments, steering interface motor(s) 118 can be driven to provide haptic feedback to a user via steering interface 112 in various scenarios. The haptic feedback can take various forms, such as a simulated detent, vibration, click, jump, tap, etc. Haptic feedback can be provided via steering interface 112 in a variety of scenarios, such as a return to manual control (e.g., based on user input or a return to manual control that is not a result of user input), gain or loss of a GPS or other location data signal, low fuel and/or power (e.g., battery level, etc.), slippage of drive and/or steering element(s), power output reaching a maximum, or other alerts, including to draw user attention to an alert indicated via another output device (e.g., an indicator light, a display screen, etc.). In embodiments employing haptic feedback for multiple distinct notifications, different notifications can have different associated haptic feedbacks (e.g., differing in one or more of intensity, pattern, etc.).

As discussed above, some embodiments can provide for user customization of features or parameters. Values for torques, steering ratios, etc. discussed herein can vary, such as based on user customization, selection between predefined values, selection between (user-customizable or predefined) modes coupling two or more features (e.g., torque(s), steering ratio, etc.). In some scenarios, one or more features can be changed during operation automatically (e.g., based on sensed conditions such as acceleration or speed, whether an operator is seated or standing, a current steering ratio, a current operating mode, etc.) and/or by an operator (e.g., selection between two or more predefined or user-defined modes, activation or deactivation of one or more torques discussed herein (either in general, or in certain operating modes such as forward or reverse), etc.).

As one non-limiting example, the first torque (e.g., which can provide a baseline resistance to movement of the steering interface) can be selectable between a first magnitude (e.g., softer controls to provide more responsive steering for operating on relatively smooth terrain, etc.) and a second magnitude greater than the first magnitude (e.g., stiffer controls to damp unintended movement of steering interface for operating on rough terrain, etc.). In some embodiments, one magnitude (e.g., the first magnitude, etc.) of the first torque can be a default value, and a user can select to activate (e.g., via switch, button, touchscreen, etc.) the second magnitude (e.g., as an independent feature, or as one of a plurality of features for certain operating conditions such as rough terrain, etc.). Additionally or alternatively, selection between values for the baseline torque can be based on sensed conditions (e.g., IMU(s) (Inertial Measurement Unit(s)) sensing accelerations associated with rough terrain, such as relatively rapid acceleration spikes, vertical oscillations occurring for at least a threshold time, etc.), or such automatic selection can be engaged by an operator (e.g., an input allowing an operator to select whether a ‘rough terrain’ mode is off, on, or activated automatically, etc.).

As another example, an operator could select between a first mode with a tighter steering ratio (e.g., smaller R) and a first (relatively higher) set of torque values, and a second mode with a looser steering ratio (e.g., larger R) and a second set of torque values lower than the first set of torque values.

Additionally or alternatively to changing feature(s) during operation, the same or other feature(s) can be altered via a configuration mode that can be made available to a user, for example, when the power equipment machine is in park, stopped, turned off, etc. (e.g., changing torque(s), center angle(s) of steering interface 112, simulated mechanical stops on steering interface 112, steering ratio, etc.). In the configuration mode, steering interface 112 (and/or other user input devices) can be used to navigate a user interface and/or select options, instead of controlling steering element(s) 122, as discussed above. Haptic feedback, as discussed above, can also be provided in the configuration mode, such as to provide feedback in response to user selection of options, etc.

### Example Embodiments

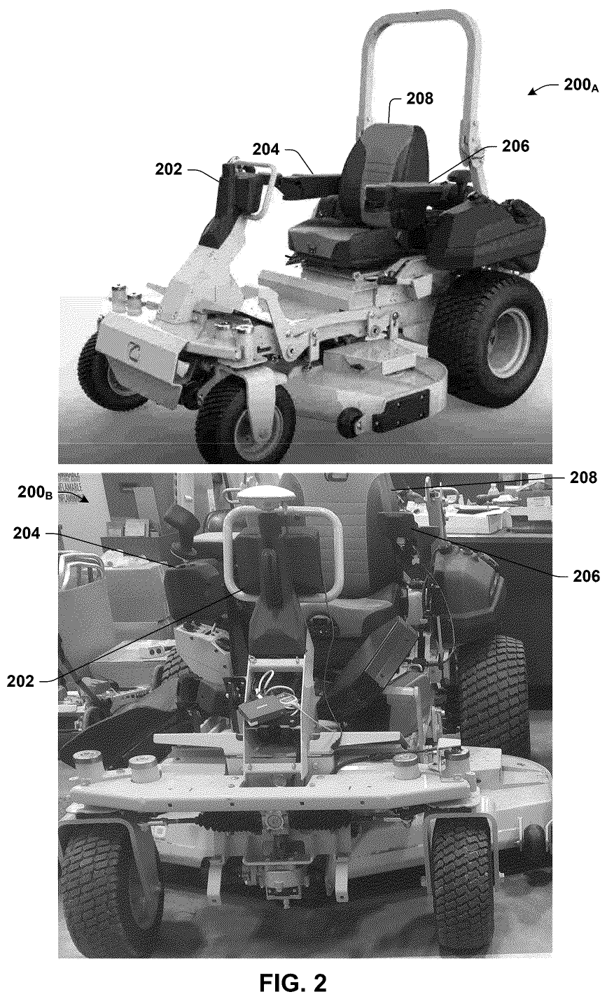

FIGS. 2-14, discussed in greater detail below, provide example embodiments, example power equipment configured to employ embodiments, and/or example components of embodiments. Although FIGS. 2-14 show specific details for the purposes of illustration, such as power equipment steered via one or more steerable wheels controlled by steering wheel, lap bars, or jogwheel, other embodiments can comprise other details or aspects (e.g., steering element(s) can be steerable wheel(s), other wheels, tracks, skids, etc.; steering interface can be steering wheel(s), lap bar(s), joystick(s), jog wheel(s), yoke, etc.). Additionally, because various embodiments employ drive-by-wire systems, a mechanical/hydrostatic/etc. link between the steering interface and steering element(s) is not necessary. As such, steering interfaces of various embodiments could be smaller, larger, shaped differently, and/or positioned differently (e.g., lap bars can be mounted from different points because they do not need to physically connect to hydrostatic transmissions, a steering wheel does not need a steering column, etc.), and can be connected to the steering element(s) in a wired or wireless manner.

Referring to FIG. 2, depicted are two images showing a first example power equipment machine 200_{A} and a second example power equipment machine 200g. according to one or more embodiments of the present disclosure. Power equipment machines 200_{A} and 200_{B} can be configured to operate in a manual operating mode, in which a user controls drive and steering interfaces of power equipment machines 200_{A} and 200_{B} and can be configured to operate in an autonomous or semi-autonomous operating mode, in which a processing device coupled with position location equipment operates the steering interfaces of power equipment machine 200_{A} or 200_{B}.

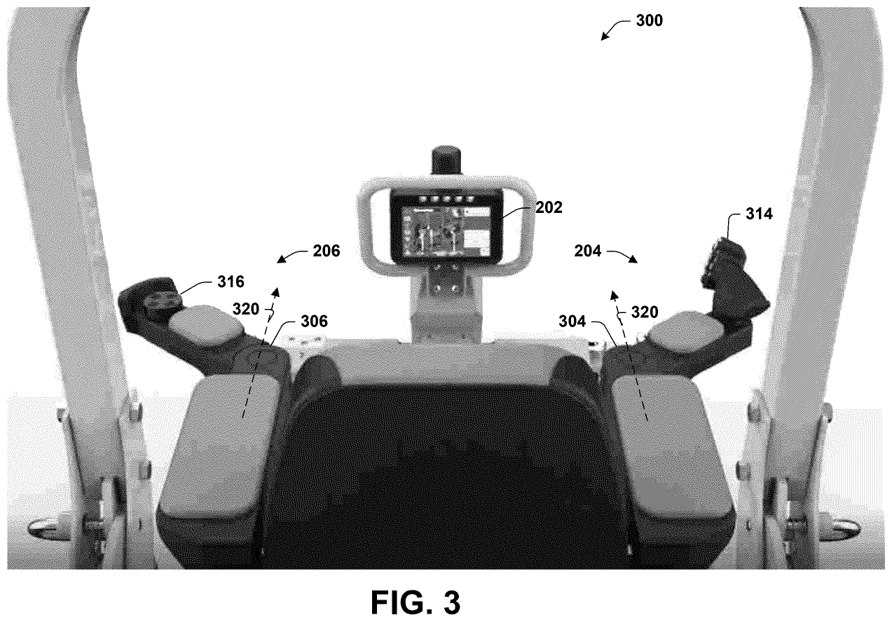

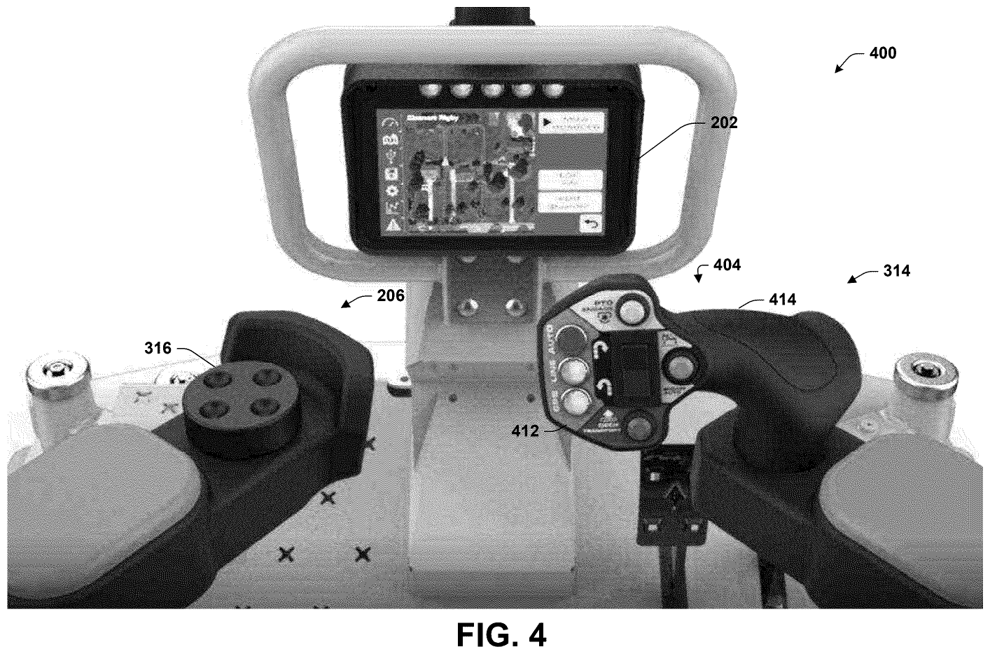

In various embodiments, power equipment machine 200_{A} or 200 includes movable arms 204, 206 (e.g., armrests, as one non-limiting example) configured to rest in multiple positions relative to a user position 208. In at least one embodiment, movable arms 204, 206 can be adjustable such that one or more of the multiple rest positions can be adjusted by a user of power equipment machine 200_{A}/200_{B}. As one example, the multiple positions can include an open position facilitating user ingress to or egress from user position 208 (e.g., see FIG. 3, below). As another example, the multiple positions can include a closed position facilitating physically securing a user within user position 208 (e.g., see FIG. 4, below). Moreover, the closed position can be configured to position manual steering interfaces of power equipment machine 200_{A}/200_{B} and autonomous guidance controls of power equipment machine 200_{A}/200_{B}, positioned on the movable arms 204, 206, at the hands of a user located at user position 208.

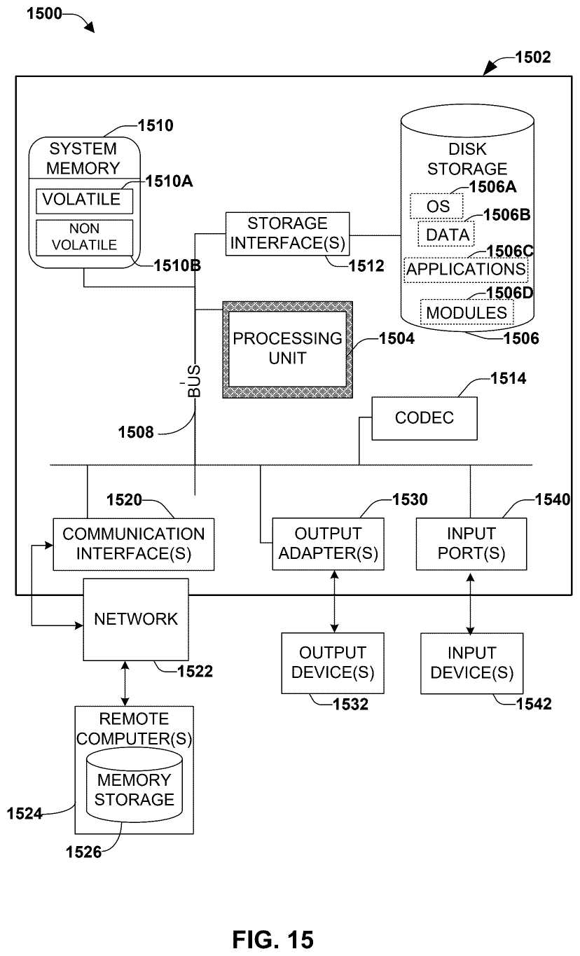

A graphical display 202 is also provided. Graphical display 202 can be electronically and communicatively connected with a control device or control unit (not depicted, but see FIG. 1, above and FIG. 15, below) of power equipment machine 200_{A}/200_{B}. Graphical display 202 can serve as a user input/output interface to view, define, modify, etc., functions of power equipment machine 200_{A}/200_{B}, such as: drive-by-wire steering system functions, operational functions, geographical boundary definition functions, pathing guidance functions, geographic boundary management functions, fuel conservation functions, settings of the control device, electrical or mechanical settings of power equipment machine 200_{A}/200_{B}, or the like, or a suitable combination of the foregoing.

Referring to FIG. 3, there is depicted another view 300 of power equipment machine 200_{A} according to additional embodiments of the present disclosure. Although not shown in FIGS. 3-9, power equipment machine 200 can have similar features to those described herein. Movable arms 204, 206 will be referred to individually as right movable arm 204 and left movable arm 206. In the embodiment illustrated by view 300, movable arms 204, 206 pivot about rotation points 304 and 306, respectively. When rotated fully away from user position 208 (e.g., as illustrated in view 300) movable arms 204, 206 can be in the open position facilitating user ingress to or egress from user position 208. When rotated fully into and in front of user position 208 (e.g., see FIG. 4, below) movable arms 204, 206 can be in the closed position physically securing a user within user position 208.

In at least one embodiment, rotation points 304, 306 can include tensioning components (e.g., mechanical tensioning component(s), a spring, tension rod, or other device for storing/applying elastic potential energy) configured to cause movable arms 204, 206 to move to one or more of the multiple rest positions from another (non-rest) position. For instance, the tensioning components can cause a movable arm 204, 206 to move to the open position or to the closed position when between such positions. In another embodiment, the tensioning components can cause a movable arm 204, 206 to move to either the open position or to the closed position when between such positions and beyond a threshold position that is between the open position and the closed position. As a specific example, the threshold position can be straight outward (e.g., along dotted arrows 320) from a rear (fixed) portion of a movable arm 204, 206 near to user position 208 and opposite rotation points 304, 306 along movable arms 204, 206 from manual steering interfaces 316 (e.g., which can be employed as steering interface system 110) and autonomous guidance controls 314. Alternatively, the threshold position can be approximately straight outward from the rear portion (e.g., within one to five degrees rotation of rotation points 304, 306 from the straight outward direction 320). When a movable arm 204, 206 is moved beyond the threshold position (e.g., in a direction of the open position), the tensioning components can impose a force to move the movable arm 204, 206 to the open position. In another embodiment, when the movable arm 204, 206 is moved beyond the threshold position (e.g., in a direction of the closed position), the tensioning components can impose a force to move the movable arm 204, 206 to the closed position. In still another embodiment, tensioning components can be provided to effect multiple threshold positions: a first threshold position beyond which rotation of movable arm 204, 206 results in a force to move the movable arm 204, 206 to the closed position, and a second threshold position beyond which rotation of movable arm 204, 206 results in a second force to move the movable arm 204, 206 to the open position.

In the embodiment(s) illustrated by image 300, manual steering interfaces 316 are provided near an end of movable arm 206, although other embodiments can position manual steering interfaces 316 at different locations on power equipment machine 200_{A}/200_{B}. Manual steering interfaces 316 include a rotational wheel or jogwheel (e.g., employable as steering interface 112), sensor or other system (e.g., Hall effect sensor, etc.) configured to generate a signal based on the angle or change/thereof of the rotational wheel or jogwheel, and digital encoder (e.g., employable as steering interface position encoder 114) configured to send a rotational steering angle signal to one of a power steering system (e.g., power steering system 120) or steering interface device (e.g., control unit 150, computer 1502 of FIG. 15, etc.) configured to convert the rotational steering angle signal to a change in direction of power equipment machine 200_{A}/200_{B}. The change in direction can be represented by a change in orientation of steerable wheels (e.g., front wheels, etc.) of power equipment machine 200_{A}/200_{B} calibrated to the rotational steering angle signal, can be represented by a change in relative speed(s) of drive wheels (e.g., rear wheels, etc.) of power equipment machine 200_{A}/200_{B} calibrated to the rotational steering angle signal, or other suitable mechanism for controlling orientation of power equipment machine 200_{A}/200_{B} on a surface. In a further embodiment, the change in direction is implemented by one or more electric motors in response to an output from the steering interface device, and mechanically independent from movement of manual steering interfaces 316. This enables manual steering interfaces 316 to be rotatable with much less force than that provided (by the electric motor(s)) to effect physical control over the turning of power equipment machine 200_{A}/200_{B}.

Autonomous guidance controls 314 are positioned near an end of movable arm 204, though the present disclosure is not limited to this example placement of autonomous guidance controls 314, and other embodiments can position such controls elsewhere on power equipment machine 200_{A}/200_{B}. In the embodiment illustrated by image 300, autonomous guidance controls 314 and manual steering interfaces 316 are moved toward a front-center placement with respect to user position 208, along movable armrests 204, 206. A user's hands can therefore naturally rest at manual steering interfaces 316 and autonomous guidance controls 314 when the user's arms are resting on movable arms 204, 206.

FIG. 4 depicts a further example image 400 of movable arms 204, 206 of power equipment machine 200_{A} in an example closed position physically securing the user. Additionally, the example closed position places manual steering interfaces 316 and autonomous guidance controls 314 at a vicinity of a user's hands, when the user's arms are resting on movable arms 204, 206. In the embodiment(s) illustrated with image 400, autonomous guidance controls 314 are formed as an ergonomic module 404 configured to be comfortable within a user's hand, when the user's arm is resting on movable arm 204. Ergonomic module 404 includes a formed surface 414 designed to comfortably support a palm of a human hand in a resting position, and a control panel 412 positioned at a resting position of a human thumb when the human hand is comfortably supported by formed surface 414. This allows the thumb to naturally engage with user input devices (pictured as buttons and rocker switch, but can include other switches, sliders, dials, and so forth) of autonomous guidance controls 314, minimizing or avoiding user fatigue when operating power equipment machine 200_{A}/200_{B}. Additionally, manual steering interfaces 316 are positioned where a user's second hand naturally rests when the user's second arm is resting on movable arm 206. As mentioned above, manual steering interfaces 316 can be operated independent of the pressure or force required to mechanically operate a steering mechanism of power equipment machine 200_{A}/200_{B}, and in an embodiment manual steering interfaces 316 can be operated with very low pressure or force configured to minimize or avoid fatigue to the user's second hand. As a result, manual steering interfaces 316 are configured to further minimize or avoid user fatigue when operating power equipment machine 200_{A}/200_{B}.

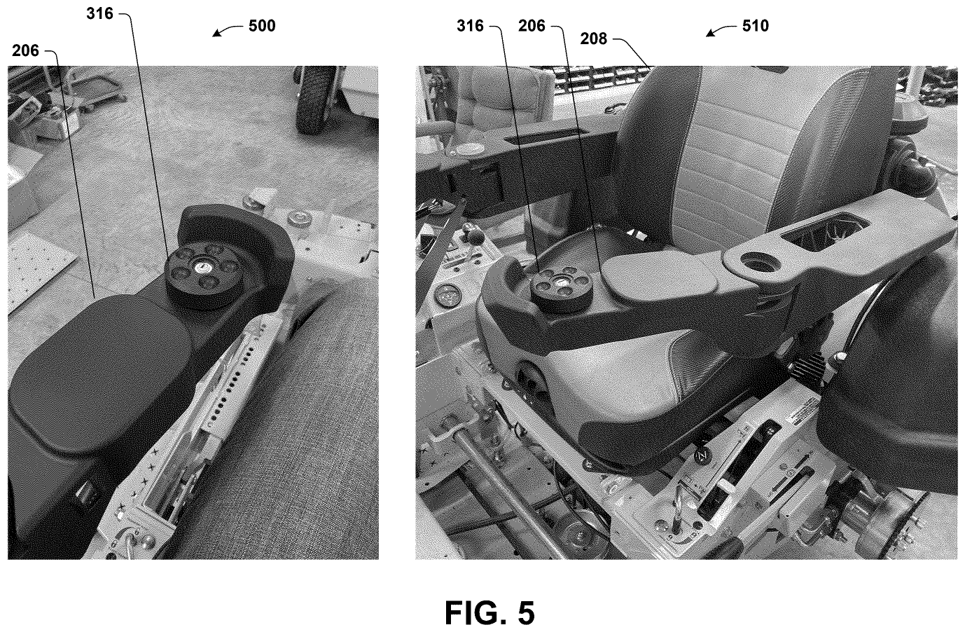

FIG. 5 illustrates additional details of movable arm 206 in connection with images 500 and 510 of a prototype embodiment of power equipment machine 200_{A}. As can be seen in FIG. 5, the specific design of the manual steering interfaces 316 can vary between embodiments, with FIG. 5 showing an embodiment of manual steering interfaces 316 having a different number of contoured depressions than that shown in FIGS. 3-4.

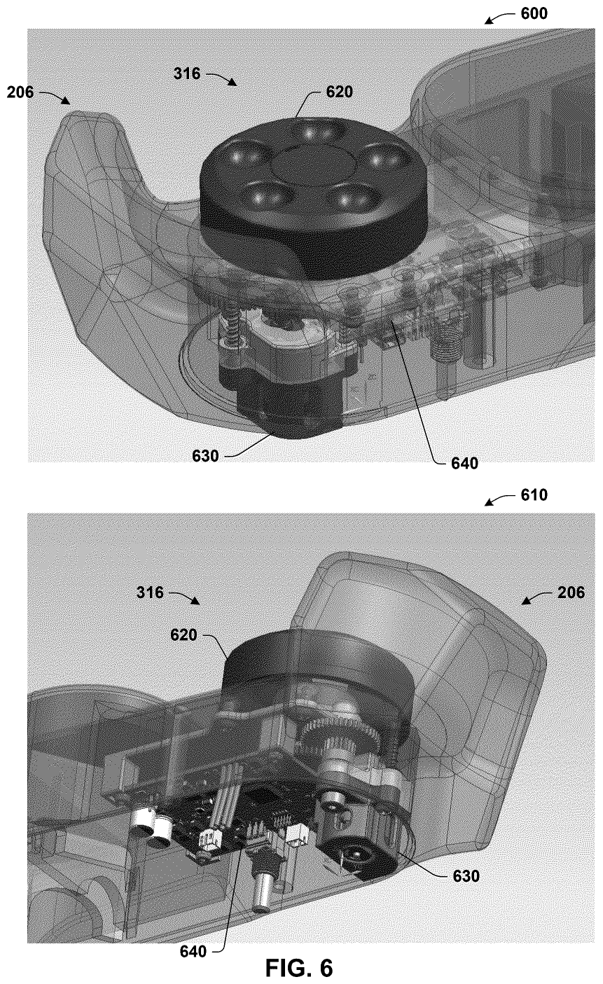

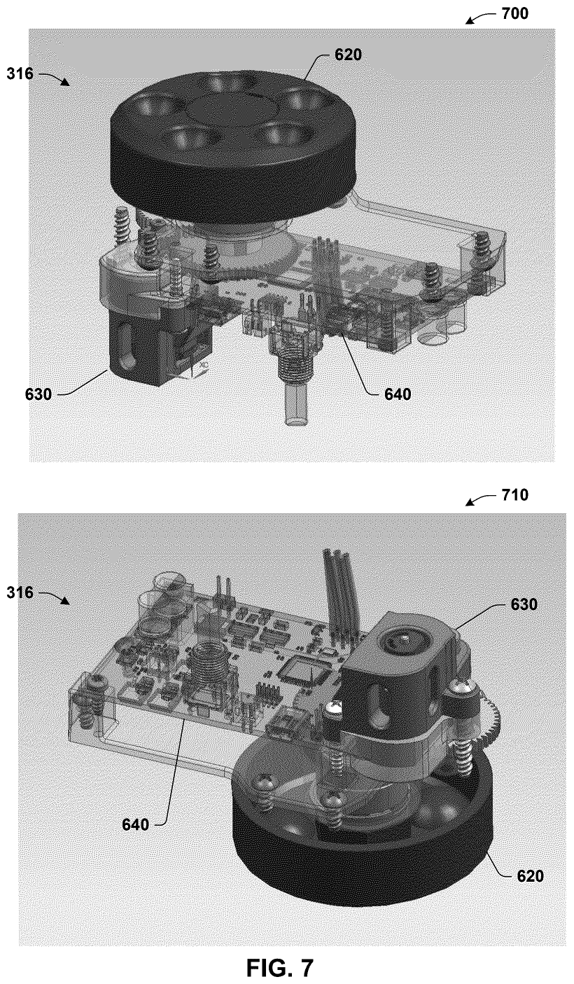

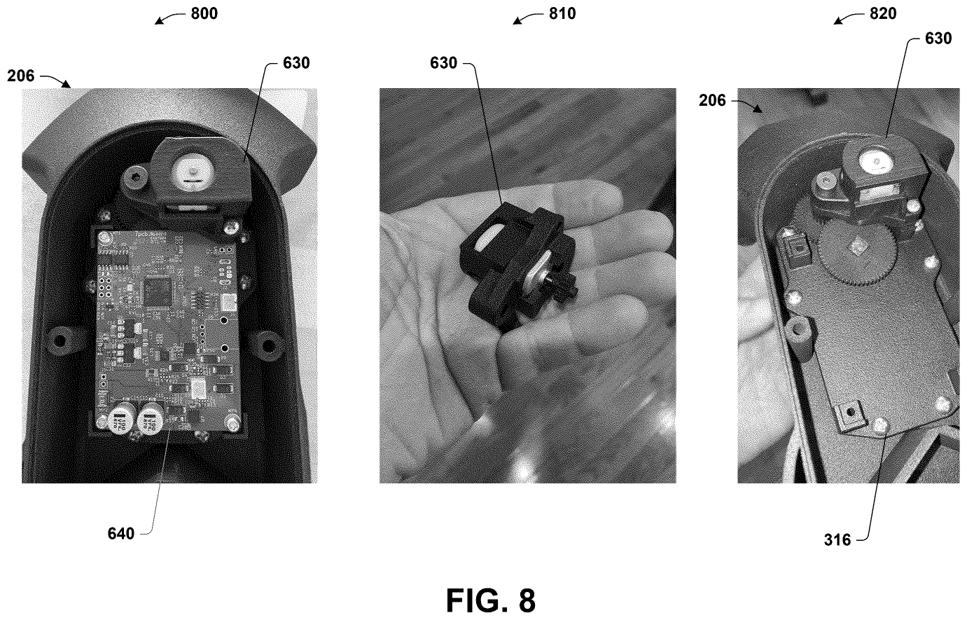

Referring to FIG. 6, illustrated are top and bottom perspective images 600 and 610, respectively, showing a cut-away view of movable arm 206 and components of a first embodiment of manual steering interfaces 316. Referring to FIG. 7, illustrated are top and bottom perspective images 700 and 710 showing components of the first embodiment of manual steering interfaces 316. Manual steering interfaces 316 comprise both electrical and mechanical components that are mechanically coupled to each other. The electrical components of manual steering interfaces 316 can be comprised in a single Printed Circuit Board Assembly (PCBA) 640, and can comprise a wheel encoder sensor (e.g., employable as steering interface position encoder 114), motor controller (e.g., employable as steering interface motor controller 116), and CAN bus communication interface. The mechanical components comprise a jogwheel interface 620 (e.g., employable as steering interface 112), feedback motor 630 (e.g., employable as steering interface motor 118), and gear reduction between feedback motor 630 and jogwheel interface 620 (the gearing reduction is 10:1 in the first embodiment, although greater or lesser gearing ratios can be employed in various embodiments). In FIGS. 6 and 7, the shaft of feedback motor 630 is parallel to the rotational axis of jogwheel interface 620. FIG. 8 illustrates images 800, 810, and 820 of a prototype of the first embodiment of manual steering interfaces 316 and components thereof.

In various embodiments, jogwheel interface 620 can be textured or constructed of material to facilitate user gripping or slowing via friction of jogwheel interface 620 (e.g., in some embodiments, it can be constructed of a material that facilitates gripping/slowing via friction and can have a uniform circular outer edge to facilitate ease of gripping/slowing via friction, etc.). For example, an inner portion of jogwheel interface 620 can be constructed of a rigid material (e.g., plastic, metal, etc.) for durability, but jogwheel interface 620 can additionally comprise a softer outer material (e.g., rubber, etc.) that improves user ability to grip jogwheel interface 620 or provide friction to counter one or more torques such as simulated caster effect torque, etc.

Alternatively, the entirety of jogwheel interface 620 can be constructed of a rigid material, but an outer surface can be textured or made of suitable material to improve user ability to grip jogwheel interface 620 or provide friction to counter one or more torques.

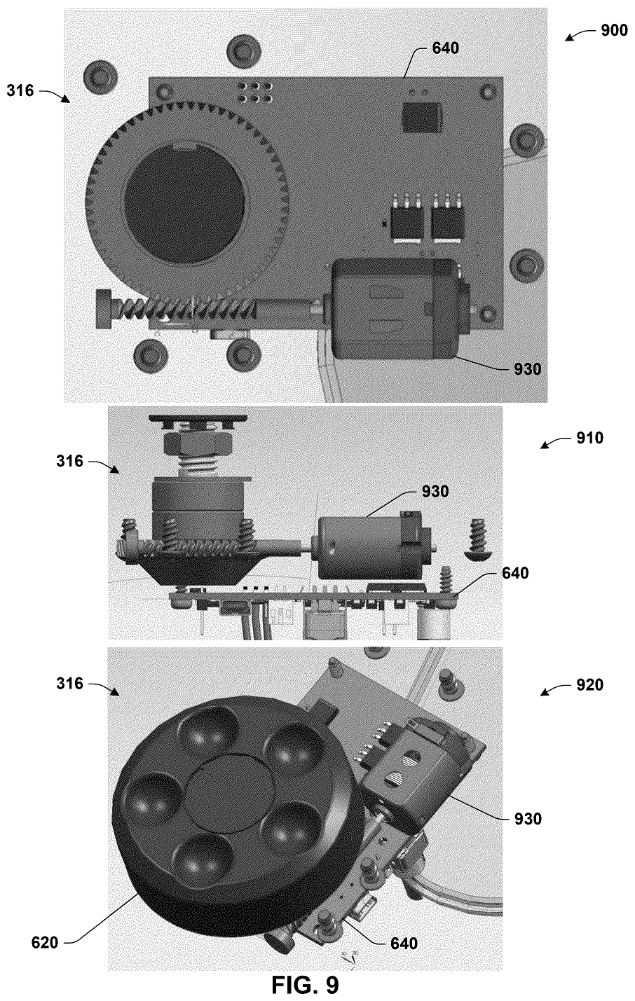

Referring to FIG. 9, illustrated are top, side, and perspective images 900, 910, and 920, respectively, showing components of a second embodiment of manual steering interfaces 316. The second embodiment of manual steering interfaces can be similar to the first embodiment of manual steering interfaces, but can comprise feedback motor 930, which can have its shaft aligned perpendicular to the rotational axis of jogwheel interface 620, instead of feedback motor 630, which has its shaft aligned parallel to the rotational axis of jogwheel interface 620.

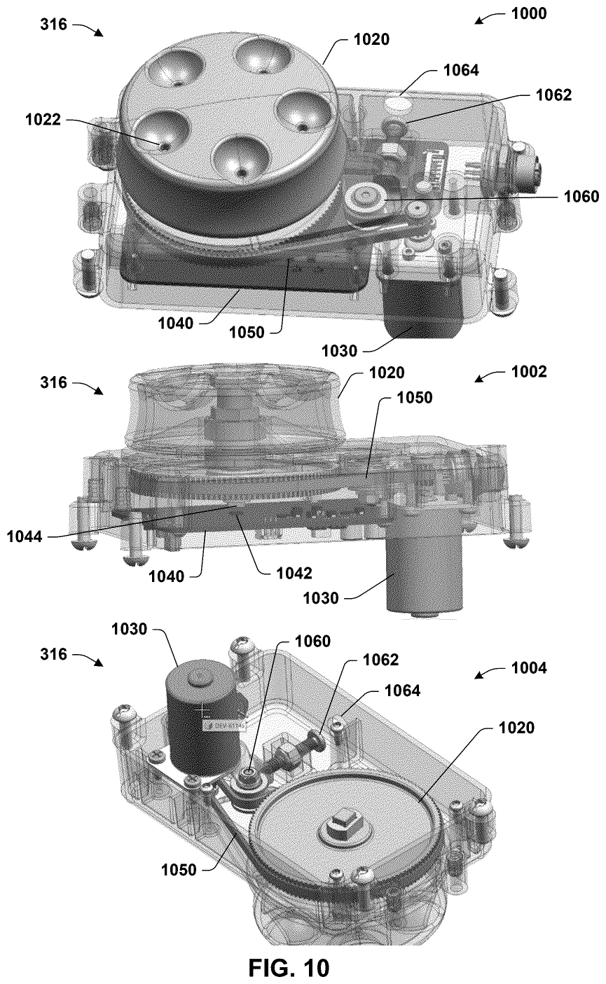

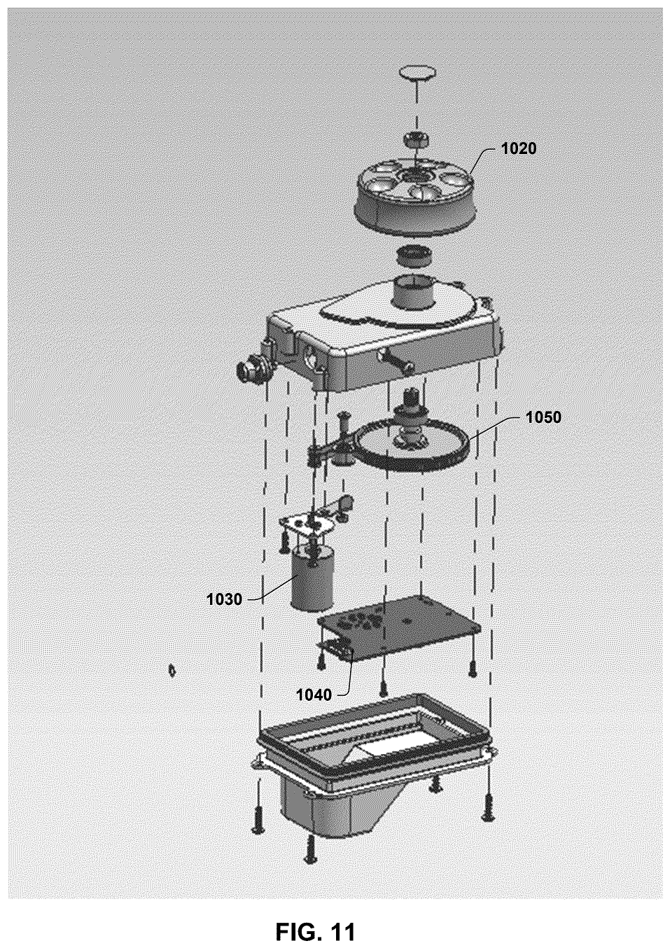

Referring to FIG. 10, illustrated are top perspective, side, and bottom perspective images 1000, 1002, and 1004, respectively, showing components of a third embodiment of manual steering interfaces 316, in connection with various aspects discussed herein. Referring to FIG. 11, illustrated is an exploded view of the third embodiment of manual steering interfaces 316, in connection with various aspects discussed herein. The third embodiment of manual steering interfaces can be similar to the first and second embodiments of manual steering interfaces. However, the third embodiment can comprise feedback motor 1030, which can have its shaft aligned parallel to but offset from the rotational axis of jogwheel interface 1020, and coupled via a timing belt 1050, instead of feedback motor 630, which has its shaft aligned parallel to the rotational axis of jogwheel interface 620 and coupled via a spur gear, or feedback motor 930, with a shaft perpendicular to the rotational axis of jogwheel interface 620 and coupled via a helical gear. Tensioner 1060 can be included also coupled to timing belt 1050, and changes in its position can be used to control the tension in timing belt 1050. A tensioning bolt (or screw, etc.) 1062 can be included to adjust the position of tensioner 1060, and manual adjustment of tensioning bolt (screw, etc.) 1062 can be accomplished by a user via access port 1064.

Additionally, image 1000 shows drain holes 1022 at the bottom of the detents that can provide for drainage of fluid (e.g., rainwater, etc.) through jogwheel interface 1020 and off power equipment machine 200_{A}/200_{B}. In various embodiments, the detents can extend near, but not all of the way to, the outer edge of jogwheel interface 1020, to provide a uniform outer edge of jogwheel interface 1020, which can facilitate a user applying pressure via a hand to slow rotation of jogwheel interface 1020 via friction.

Image 1002 also shows Hall effect sensor 1042, which can be on PCBA 1040 and aligned along the axis of jogwheel interface 1020 near a magnet 1044 mounted on jogwheel interface 1020, to sense changes in the angle of magnet 1044 (and thereby sense changes in the angle of jogwheel interface 1020).

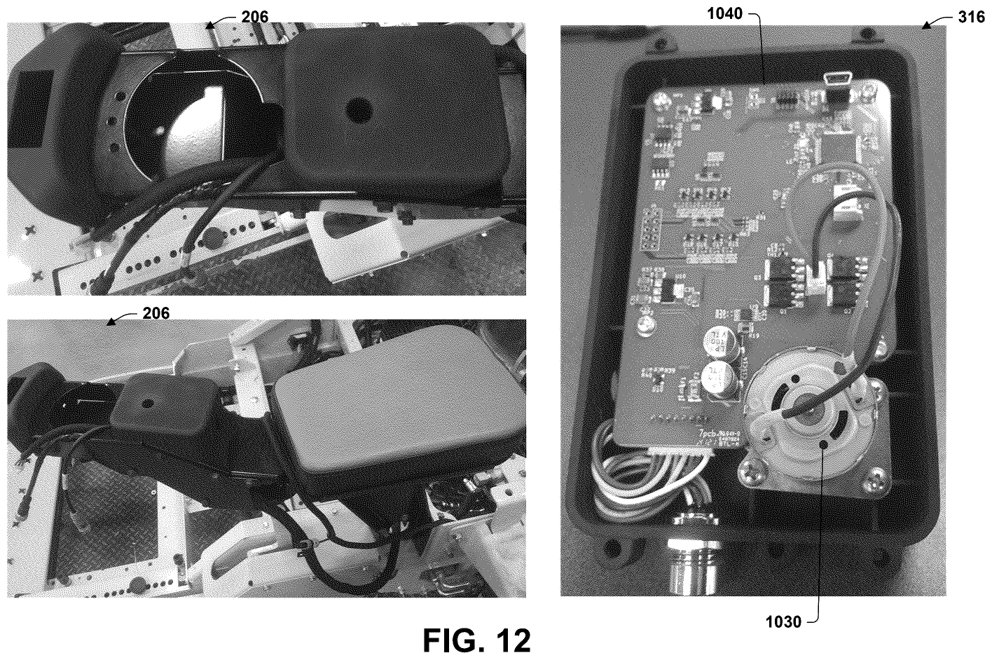

Referring to FIG. 12, illustrated are two images (left) of movable armrest 206 of a prototype of power equipment machine 200_{B} (without manual steering interfaces 316) and a bottom view of a prototype of the third embodiment of manual steering interfaces 316, in connection with various aspects discussed herein.

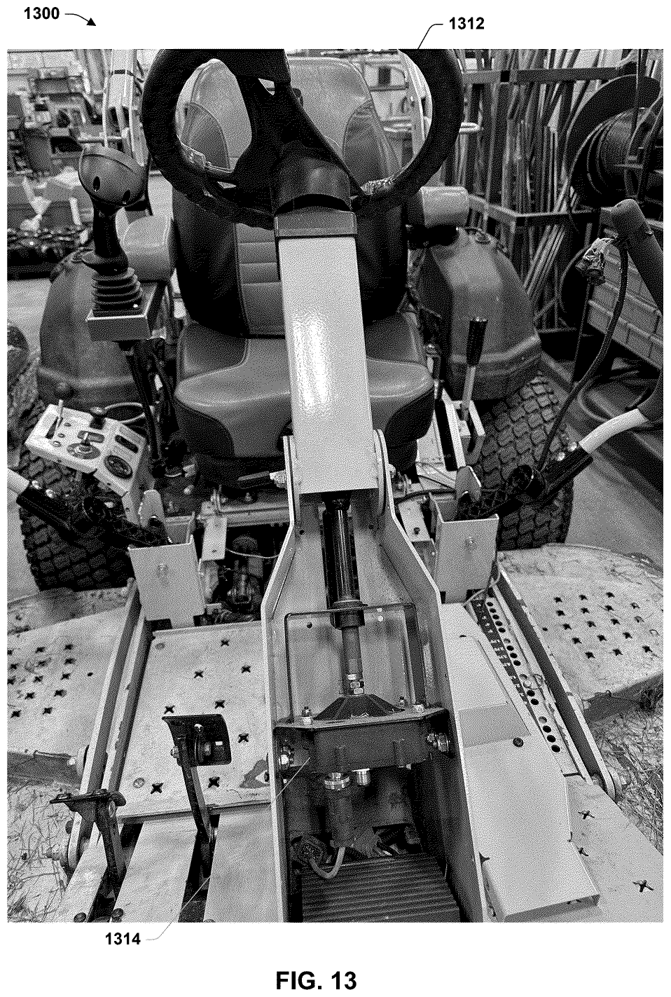

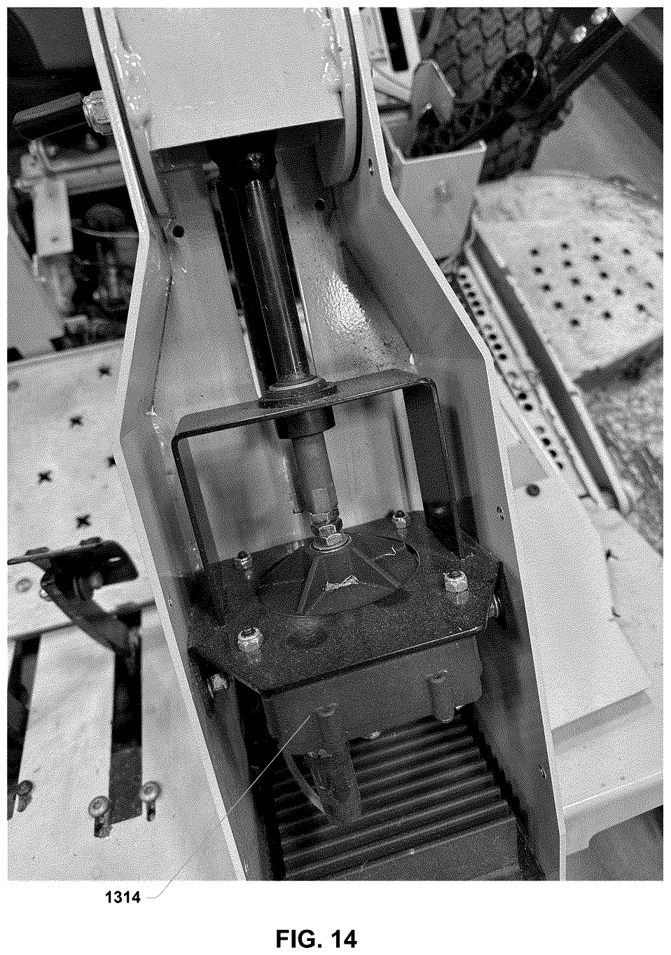

Referring to FIG. 13, illustrated is an image of a example power equipment machine 1300 comprising a steering wheel 1312 as a steering interface, employable in connection with various embodiments discussed herein. FIG. 13 shows steering wheel 1312 arranged on a steering column but connected to electronic components 1314 that can include a position encoder, steering interface motor controller, etc. instead of mechanically linked to steering element(s). Referring to FIG. 14, illustrated is a second image of example power equipment machine 1300, showing a closer view of electronic components 1314, in connection with various aspects discussed herein. In other embodiments, a steering wheel or other steering interface can be remote or connected to substantially any portion of the power equipment machine (e.g., on a movable arm similar to those shown in FIGS. 2-5, etc.). Although not shown in FIGS. 13-14, a steering interface motor can be coupled to steering wheel 1312 via a timing belt as with steering interface 1316. Alternatively, steering interface motor(s) can be coupled to steering interfaces (e.g., steering wheel(s), lap bar(s), joystick(s), jogwheel(s) via any of a variety of other means such as chains, spur gears, bevel gears, worm gears, planetary gearsets, etc.

Additionally, some embodiments can employ springs to bias a steering interface to its center angle instead of or in addition to torques delivered by motor(s), while allowing the center angle (the spring center) to be adjustable. For example, a steering interface can be coupled to a neutral pin linked to springs that bias the steering interface toward a center angle associated with the neutral pin. However, the neutral pin can be movable, such as by coupling it to a spur gear that can be rotated to adjust the position of the neutral pin and center angle.

In connection with FIG. 15, the systems and processes described herein can be embodied within hardware, such as a single integrated circuit (IC) chip, multiple ICs, an application specific integrated circuit (ASIC), or the like. A suitable operating environment 1500 for implementing various aspects of the claimed subject matter includes a computer 1502. In various embodiments, a control unit (e.g., control unit 150, etc.) of a power equipment machine can be embodied in part by computer 1502, or an analogous computing device known in the art, subsequently developed, or made known to one of ordinary skill in the art by way of the context provided herein.

The computer 1502 includes a processing unit 1504, a system memory 1510, a codec 1514, and a system bus 1508. The system bus 1508 couples system components including, but not limited to, the system memory 1510 to the processing unit 1504. The processing unit 1504 can be any of various available processors. Dual microprocessors and other multiprocessor architectures also can be employed as the processing unit 1504.

The system bus 1508 can be any of several types of bus structure(s) including the memory bus or memory controller, a peripheral bus or external bus, or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1510 can include volatile memory 1510A, non-volatile memory 1510B, or both. Functions of a control unit (among other control units: 150, etc., depicted herein) described in the present specification can be programmed to system memory 1510, in various embodiments. The basic input/output system (BIOS), containing the basic routines to transfer information between elements within the computer 1502, such as during start-up, is stored in non-volatile memory 1510B. In addition, according to present innovations, codec 1514 may include at least one of an encoder or decoder, wherein the at least one of an encoder or decoder may consist of hardware, software, or a combination of hardware and software. Although, codec 1514 is depicted as a separate component, codec 1514 may be contained within non-volatile memory 1510B. By way of illustration, and not limitation, non-volatile memory 1510B can include read only memory (ROM), programmable ROM (PROM), electrically programmable ROM (EPROM), electrically erasable programmable ROM (EEPROM), or Flash memory. Non-volatile memory 1510B can be embedded memory (e.g., physically integrated with computer 1502 or a mainboard thereof), or removable memory. Examples of suitable removable memory can include a secure digital (SD) card, a compact Flash (CF) card, a universal serial bus (USB) memory stick, or the like. Volatile memory 1510A includes random access memory (RAM), which can serve as operational system memory for applications executed by processing unit 1504. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM), and so forth.

Computer 1502 may also include removable/non-removable, volatile/non-volatile computer storage medium. FIG. 15 illustrates, for example, disk storage 1506. Disk storage 1506 includes, but is not limited to, devices such as a magnetic disk drive, solid state disk (SSD) floppy disk drive, tape drive, Flash memory card, memory stick, or the like. In addition, disk storage 1506 can include storage medium separately or in combination with other storage medium including, but not limited to, an optical disk drive such as a compact disk ROM device (CD-ROM) or derivative technology (e.g., CD-R Drive, CD-RW Drive, DVD-ROM, and so forth). To facilitate connection of the disk storage 1506 to the system bus 1508, a removable or non-removable interface is typically used, such as interface 1512. In one or more embodiments, disk storage 1506 can be limited to solid state non-volatile storage memory, providing motion and vibration resistance for a control unit (e.g., control unit 150, among others) operable in conjunction with a power equipment machine (e.g., power equipment machine 200, etc.).

It is to be appreciated that FIG. 15 describes software that can program computer 1502 to operate as an intermediary between a user of a power equipment machine (e.g., power equipment machine 200, and others), or operate as an intermediary between the power equipment machine and an autonomous steering system (or partially autonomous, user-assisted steering system) for operating the power equipment machine embodied within operating environment 1500. Such software includes an operating system 1506A. Operating system 1506A, which can be stored on disk storage 1506, acts to control and allocate resources of the computer 1502. Applications 1506C take advantage of the management of resources by operating system 1506A through program modules 1506D, and program data 1506B, such as the boot/shutdown transaction table and the like, stored either in system memory 1510 or on disk storage 1506. It is to be appreciated that the claimed subject matter can be implemented with various operating systems or combinations of operating systems.

Input device(s) 1542 connects to the processing unit 1504 and facilitates user interaction with operating environment 1500 through the system bus 1508 via interface port(s) 1530. Input port(s) 1540 can include, for example, a serial port, a parallel port, a game port, a universal serial bus (USB), among others. Output device(s) 1532 use some of the same type of ports as input device(s) 1542. Thus, for example, a USB port may be used to provide input to computer 1502 and to output information from computer 1502 to an output device 1532. Output adapter 1530 is provided to illustrate that there are some output devices, such as graphic display, speakers, and printers, among other output devices, which require special adapters. The output adapter 1530 can include, by way of illustration and not limitation, video and sound cards that provide a means of connection between the output device 1532 and the system bus 1508. It should be noted that other devices or systems of devices provide both input and output capabilities such as remote computer(s) 1524 and memory storage 1526.

Computer 1502 can operate in conjunction with one or more electronic devices described herein. For instance, computer 1502 can embody a power equipment control unit 150 configured to operate steering interface system 120 and a motor to provide autonomous or semi-autonomous driving (including autonomous turning), as described herein. Additionally, computer 1502 can communicatively couple with steering interface system 110 to suspend driving of steering interface motor 118 from providing various torques to steering interface 112 during autonomous and/or semi-autonomous driving, as well as to end autonomous and/or semi-autonomous operation and return to a manual mode in response to certain inputs from steering interface 112.

Communication connection(s) 1520 refers to the hardware/software employed to connect the network interface 1522 to the system bus 1508. While communication connection 1520 is shown for illustrative clarity inside computer 1502, it can also be external to computer 1502. The hardware/software necessary for connection to the network interface 1522 includes, for exemplary purposes only, internal and external technologies such as, modems including regular telephone grade modems, cable modems and DSL modems, ISDN adapters, and wired and wireless Ethernet cards, hubs, and routers.

In regard to the various functions performed by the above described components, machines, devices, processes and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments include a system as well as electronic hardware configured to implement the functions, or a computer-readable medium having computer-executable instructions for performing the acts or events of the various processes.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In other embodiments, combinations or sub-combinations of the above disclosed embodiments can be advantageously made. The block diagrams of the architecture and flow charts are grouped for ease of understanding. However, it should be understood that combinations of blocks, additions of new blocks, re-arrangement of blocks, and the like are contemplated in alternative embodiments of the present disclosure.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A drive-by-wire steering system for a power equipment machine, comprising:
a steering interface system comprising:
a steering interface configured to receive rotational input from a user;
one or more steering interface position encoders configured to determine a control angular displacement of the steering interface relative to a center angle of the steering interface;
one or more steering interface motors configured to rotate the steering interface; and
one or more steering interface motor controllers configured to control activation of the one or more steering interface motors to apply one or more torques to the steering interface;
a power steering system comprising,
one or more steering elements;
one or more steering position encoders configured to determine an output angular displacement of the one or more steering elements relative to a center angle of the one or more steering elements;
one or more steering motors configured to drive the one or more steering elements; and
one or more steering motor controllers configured to control activation of the one or more steering motors to drive the one or more steering elements toward a target output angular displacement, wherein the target output angular displacement is based on the control angular displacement and a steering ratio,
wherein the steering interface system and the power steering system communicate via a communication link, wherein the communication link is one of a wired communication link or a wireless communication link.

2. The drive-by-wire steering system of claim 1, wherein the one or more torques comprise a first torque, wherein the first torque has a first magnitude that is applied in opposition to the rotational input.

3. The drive-by-wire steering system of claim 2, wherein the steering interface motor controller is configured to one of increase or decrease the first magnitude in response to one or more of an operator input or at least one sensed condition.

4. The drive-by-wire steering system of claim 3,
wherein the at least one sensed condition comprises acceleration data associated with the power equipment machine operating on rough terrain;
wherein the steering interface motor controller is configured to increase the first magnitude in response to the at least one sensed condition; and
wherein the steering interface motor controller is configured to one of increase the first magnitude simultaneously with a decrease in the steering ratio or decrease the first magnitude simultaneously with an increase in the steering ratio.

5. The drive-by-wire steering system of claim 1, wherein the center angle of the steering interface is fixed.

6. The drive-by-wire steering system of claim 1, wherein the one or more steering motor controllers are configured to control activation of the one or more steering motors to drive the one or more steering elements according to one of autonomous or semi-autonomous operation.

7. The drive-by-wire steering system of claim 6, wherein the one or more steering interface motor controllers are configured to control activation of the one or more steering interface motors to drive the steering interface to one or more control angular displacements that correspond to one or more output angular displacements of the one or more steering elements during the one of autonomous or semi-autonomous operation.

8. The drive-by-wire steering system of claim 1, wherein the one or more torques comprise a sixth torque, wherein the sixth torque is applied in opposition to the rotational input, and wherein the sixth torque has a magnitude that depends on a load of each of the one or more steering motors.

9. The drive-by-wire steering system of claim 1,
wherein the one or more steering motor controllers are configured to control activation of the one or more steering motors to drive the one or more steering elements according to a calibration operation, and
wherein the one or more steering interface motor controllers are configured to control activation of the one or more steering interface motors to drive the steering interface to one or more control angular displacements that correspond to one or more output angular displacements of the one or more steering elements during the calibration operation.

10. The drive-by-wire steering system of claim 1, further comprising a control unit configured to redefine the center angle of the steering interface such that the control angular displacement corresponds to the output angular displacement based on the steering ratio, in response to one or more of: the power equipment machine being turned on, or an end of one of autonomous or semi-autonomous operation.

11. A steering interface system, comprising:
a steering interface configured to receive rotational input from a user;
a steering interface position encoder configured to determine a control angular displacement of the steering interface relative to a center angle of the steering interface;
a steering interface motor configured to rotate the steering interface;
a steering interface motor controller configured to control activation of the steering interface motor to apply one or more torques to the steering interface; and
a communication interface configured to output first data that indicates the control angular displacement and receive second data that indicates a heading of a power equipment machine, wherein the heading is based at least in part on the control angular displacement and a steering ratio.

12. The steering interface system of claim 11, wherein the one or more torques comprise a first torque, wherein the first torque has a first magnitude that is applied in opposition to the rotational input.

13. The steering interface system of claim 12, wherein the steering interface motor controller is configured to one of increase or decrease the first magnitude in response to one or more of an operator input or at least one sensed condition.

14. The steering interface system of claim 12, wherein the steering interface motor controller is configured to one of increase the first magnitude simultaneously with a decrease in the steering ratio or decrease the first magnitude simultaneously with an increase in the steering ratio.

15. The steering interface system of claim 11, wherein the center angle of the steering interface is fixed.

16. A drive-by-wire steering system, comprising:
a steering interface system comprising:
a steering interface configured to receive rotational input from a user;
one or more steering interface position encoders configured to determine a control angular displacement of the steering interface relative to a center angle of the steering interface;
one or more steering interface motors configured to rotate the steering interface; and
one or more steering interface motor controllers configured to control activation of the one or more steering interface motors to apply one or more torques to the steering interface;
a power steering system comprising,
one or more steering elements;
one or more steering position encoders configured to determine an output angular displacement of the one or more steering elements relative to a center angle of the one or more steering elements;
one or more steering motors configured to drive the one or more steering elements;
one or more steering motor controllers configured to control activation of the one or more steering motors to drive the one or more steering elements toward a target output angular displacement, wherein the target output angular displacement is based on the control angular displacement and a steering ratio; and
a Controller Area Network (CAN) bus that facilitates communication between the steering interface system and the power steering system.

17. The drive-by-wire steering system of claim 16, wherein the one or more torques comprise a first torque, wherein the first torque has a first magnitude that is applied in opposition to the rotational input.

18. The drive-by-wire steering system of claim 17, wherein the steering interface motor controller is configured to one of increase or decrease the first magnitude in response to one or more of an operator input or at least one sensed condition.

19. The drive-by-wire steering system of claim 18,
wherein the at least one sensed condition comprises acceleration data associated with the power equipment machine operating on rough terrain;
wherein the steering interface motor controller is configured to increase the first magnitude in response to the at least one sensed condition; and
wherein the steering interface motor controller is configured to one of increase the first magnitude simultaneously with a decrease in the steering ratio or decrease the first magnitude simultaneously with an increase in the steering ratio.

20. The drive-by-wire steering system of claim 16, wherein the center angle of the steering interface is fixed.
